(19) United States
(12) Patent Application Publication
(10) Pub. No.: US 2023/0295468 A1
(43) Pub. Date: Sep. 21, 2023

(54) PRESSURE-SENSITIVE ADHESIVE SHEET

(71) Applicant: NITTO DENKO CORPORATION, Ibaraki-shi, Osaka (JP)

(72) Inventors: Masataka NISHIWAKI, Ibaraki-shi, Osaka (JP); Kazuki MINOURA, Ibaraki-shi, Osaka (JP); Yasushi BUZOJIMA, Ibaraki-shi, Osaka (JP)

(73) Assignee: NITTO DENKO CORPORATION, Ibaraki-shi, Osaka (JP)

(21) Appl. No.: 17/796,110

(22) PCT Filed: Jan. 25, 2021
(86) PCT No.: PCT/JP2021/002429

§ 371 Date: Jul. 28, 2022

(30) Foreign Application Priority Data
Jan. 31, 2020 (JP) 2020-015791

(51) Int. Cl. C09J 7/25; C09J 7/22; C09J 133/08; C08K 3/04

(52) U.S. Cl. CPC C09J 7/25; C08K 3/04; C09J 7/22; C09J 133/08; C08K 2201/003

(57) ABSTRACT

Provided is a novel PSA sheet having good impact resistance as well as an increased refractive index. The present invention provides an adhesively double-faced PSA sheet that consists of a PSA layer and is free of a substrate. The PSA sheet has a refractive index of 1.50 or higher as well as a breaking strength of 10 MPa or less.

### TECHNICAL FIELD

The present invention relates to a pressure-sensitive adhesive sheet. The present application claims priority to Japanese Patent Application No. 2020-15791 filed Jan. 31, 2020; the entire content of which is incorporated herein by reference.

### BACKGROUND ART

In general, pressure-sensitive adhesive (PSA) exists as a soft solid (a viscoelastic material) in a room temperature range and has a property to adhere easily to an adherend with some pressure applied. With such properties, PSA is widely used for purposes such as bonding, fixing and protecting components inside portable electronic devices such as cell phones. Literatures related to PSA sheets used in portable electronic devices include Patent Document 1. Patent Documents 2 and 3 teach PSA sheets applied to polarizing film in liquid crystal display devices, etc.

### CITATION LIST

### Patent Literature

[Patent Document 1] Japanese Patent Application Publication No. 2017-57375
[Patent Document 2] WO 2015/108159
[Patent Document 3] Japanese Patent Application Publication No. 2019-196468

### SUMMARY OF INVENTION

### Technical Problem

For instance, portable electronic devices are susceptible to being dropped because of their usage and PSA sheets used in portable electronic devices need to have impact resistance. For instance, a PSA placed on the backside of a display screen in a portable electronic device desirably has excellent impact resistance therein. For impact resistance enhancement, it is effective to use an impact-absorbing material such as a foam body. As for fixing components in the portable electronic devices, thinning (thickness reduction) is underway in response to needs for weight saving and downsizing. This creates hesitation towards the use of thick impact-absorbing materials such as foam substrates.

Various devices such as the aforementioned sort of portable electronic devices use optical sensors using light such as infrared (IR) light, visible light and ultraviolet (UV) light for purposes including device operation, nearby object detection, detection of the surrounding brightness (ambient light) and data communication. The light used in an optical sensor passes through the material constituting the device to actuate the intended function; however, when the light is blocked by the sort of reflection inside the device, it may affect sensor accuracy or cause poor sensor response. As for the PSA sheet used in the device, when the difference in refractive index is large between itself and the member to which the PSA sheet is applied, the light may be reflected at their interface, badly affecting the accuracy of the optical sensor. For instance, among materials to which a PSA is applied (such as back materials placed on backsides of image displays), many have higher refractive indices than the PSA. The difference in refractive index between the PSA sheet and the adherend may cause light reflection at the interface between the two. As the PSA sheet placed on the backside of the image display, one having light-blocking properties can be used to reduce reflection of the light through the screen and prevent reduction of visibility. In such a light-blocking PSA sheet, when the light that should be absorbed in the PSA sheet is reflected at the interface between the PSA sheet and the adherend, it may cause malfunction or poor response.

With respect to PSA sheets requiring such impact resistance, studies have not been conducted on reducing the light reflection caused by the difference in refractive index from the adherend. If a PSA sheet capable of reducing light reflection while having impact resistance is provided, it has great practical advantages in applications requiring impact resistance (e.g., portable electronic devices), such as an ability to prevent the aforementioned decrease in optical sensor accuracy.

The present invention has been made in view of these circumstances with an objective to provide a novel PSA sheet having good impact resistance with an increased refractive index.

### Solution to Problem

This Description provides an adhesively double-faced PSA sheet that consists of a PSA layer and is free of a substrate. The PSA sheet has a refractive index of 1.50 or higher and a breaking strength of 10 MPa or less. When applied to an adherend having good impact resistance as well as a higher refractive index than general PSAs, the PSA sheet in this embodiment can reduce light reflection at the interface with the adherend. Having no substrate, the substrate-free double-faced PSA sheet can be made thinner by that much, possibly contributing to downsizing and space saving in products to which the double-faced PSA sheet is applied. In a substrate-free PSA sheet, the effect of the PSA layer such as adhesive strength and impact resistance can be maximized.

The PSA sheet disclosed herein may comprise at least one species of particles P_{HRI} selected among metal particles, metal compound particles, organic particles and organic/inorganic composite particles. This can preferably achieve at least the prescribed refractive index value. In particular, the PSA sheet preferably comprises particles formed of a metal oxide as the particles P_{HRI}.

In some preferable embodiments, the particle P_{HRI} content of the PSA sheet is 25% to 75% by weight. When the particle P_{HRI} content is 25% by weight or higher, the refractive index of the PSA sheet can be preferably increased. When the particle P_{HRI} content is 75% by weight or lower, good impact resistance is likely to be retained.

In some preferable embodiments, the particles P_{HRI} have a mean particle diameter in the range between 1 nm and 100 nm. With the use of particles P_{HRI} having the mean particle diameter in this range, while suppressing degradation of properties such as impact resistance and adhesive strength, at least the prescribed refractive index value can be preferably obtained.

The PSA sheet according to some preferable embodiments comprise carbon black particles in addition to the particles P_{HRI}. This embodiment can have good light-blocking properties with an increased refractive index.

The PSA sheet according to some preferable embodiments has a thickness of 20 µm or greater and 50 µm or less. When the PSA sheet thickness is 20 µm or greater, superior impact resistance can be preferably obtained. With the PSA sheet thickness being 50 µm or less, it may well accommodate needs for thinning (thickness reduction) and weight saving.

The PSA sheet disclosed herein may comprise an acrylic polymer as base polymer. In an embodiment having an acrylic PSA, an increase in refractive index can be preferably obtained by the art disclosed herein.

The PSA sheet according to some preferable embodiments is formed from a PSA composition comprising an isocyanate-based crosslinking agent and/or an epoxy-based crosslinking agent. Such an embodiment can bring about an increase in cohesion while having good impact resistance. In other words, both cohesion and impact resistance are likely to be obtained.

The PSA sheet according to some preferable embodiments has a 180° peel strength of 2 N/10 mm or greater to a stainless steel plate. Such a PSA sheet can have good adhesion in addition to impact resistance and an increased refractive index.

The PSA sheet disclosed herein has impact resistance. Thus, it can be preferably used, for instance, in order to bond (typically fix) a member of a portable electronic device susceptible to being dropped because of its usage. The portable electronic device may include an optical sensor. The use of the PSA sheet disclosed herein can reduce light reflection, thereby lessening the influence on operation of the optical sensor.

### BRIEF DESCRIPTION OF DRAWINGS

FIG. 1 shows a cross-sectional diagram schematically illustrating a structural example of the PSA sheet.

FIG. 2 shows a cross-sectional diagram schematically illustrating another structural example of the PSA sheet.

FIG. 3 shows an exploded perspective view schematically illustrating a constitutional example of a liquid crystal display.

FIG. 4 shows a histogram of the number-based particle size distribution of particles P_{HRI} in the PSA according to Example 1 by TEM analysis.

FIG. 5 shows a histogram of the number-based particle size distribution of particles P_{HRI} in the PSA according to Example 7 by TEM analysis.

### DESCRIPTION OF EMBODIMENTS

Preferable embodiments of the present invention are described below. Matters necessary to practice this invention other than those specifically referred to in this description may be comprehended by a person of ordinary skill in the art based on the instruction regarding implementations of the invention according to this description and the common technical knowledge in the pertinent field. The present invention can be practiced based on the contents disclosed in this description and common technical knowledge in the subject field. In the drawings referenced below, a common reference numeral may be assigned to members or sites producing the same effects, and duplicated descriptions are sometimes omitted or simplified. The embodiments described in the drawings are schematized for clear illustration of the present invention, and do not necessarily represent the accurate sizes or reduction scales of the PSA sheet to be provided as an actual product by the present invention.

As used herein, the term “PSA” refers to, as described earlier, a material that exists as a soft solid (a viscoelastic material) in a room temperature range and has a property to adhere easily to an adherend with some pressure applied. As defined in “Adhesion: Fundamental and Practice” by C. A. Dahlquist (McLaren & Sons (1966), P. 143), PSA referred to herein may generally be a material that has a property satisfying complex tensile modulus E^{∗} (1 Hz) < 10⁷ dyne/cm² (typically, a material that exhibits the described characteristics at 25° C.).

### Constitutional Examples of PSA Sheet

The PSA sheet disclosed herein is a substrate-free PSA sheet (i.e., a PSA sheet free of a nonreleasable substrate) in the form of a PSA layer held on a release liner. The concept of PSA sheet herein may encompass so-called PSA tape, PSA labels, PSA film, etc. The PSA sheet disclosed herein can be in a roll or in a flat sheet. Alternatively, the PSA sheet may be processed into various shapes.

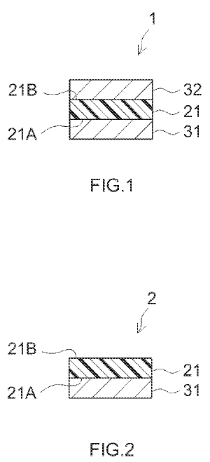

FIGS. 1 and 2 illustrate structural examples of the substrate-free double-faced PSA sheet (substrate-free PSA sheet of the adhesively double-faced type). In a PSA sheet 1 shown in FIG. 1, both faces 21A and 21B of a substrate-free PSA layer 21 are protected with release liners 31 and 32, respectively, each liner having a release face on at least the PSA layer side. In a PSA sheet 2 shown in FIG. 2, one surface (adhesive face) 21A of a substrate-free PSA layer 21 is protected with release liner 31 having a release face on each side. This can be wound so that the other surface (adhesive face) 21B of PSA layer 21 is brought into contact with the backside of release liner 31, with the other face 21B also protected with release liner 31. From the viewpoint of reducing the PSA sheet thickness, the art disclosed herein can be preferably implemented in such a substrate-free form. The substrate-free PSA sheet can be easily made thinner and is also advantageous for possible maximization of PSA properties such as adhesive strength and impact resistance.

### Properties of PSA Sheet

### Breaking Strength

The PSA sheet disclosed herein is characterized by having a breaking strength of 10 MPa or less. According to the PSA sheet having a breaking strength of 10 MPa or less, good impact resistance can be obtained. The breaking strength is, for instance, less than 10 MPa, possibly 8 MPa or less, more preferably 7 MPa or less, yet more preferably 6 MPa or less, particularly preferably 5 MPa or less, or possibly even 3 MPa or less (e.g., 1 MPa or less). The minimum breaking strength is not particularly limited. From the standpoint of retaining adhesive properties such as holding power, it is suitably 0.1 MPa or greater, preferably 0.5 MPa or greater, more preferably 1 MPa or greater, possibly 2 MPa or greater, 3 MPa or greater, or even 4 MPa or greater. The PSA sheet having at least a prescribed strength value tends to show excellent handling properties. The breaking strength is determined by the method described later in Examples.

### Refractive Index

The PSA sheet disclosed herein is characterized by having a refractive index of 1.50 or higher. Having these characteristics, when applied to a material having a higher refractive index than the PSA, light reflection can be reduced at the interface between the two. For instance, regarding a light-blocking PSA sheet, it is not desirable that the light that should be absorbed in the PSA sheet is reflected at the interface with the adherend. In such an embodiment, it is particularly significant to reduce light reflection while having an increased refractive index. From such a standpoint, the refractive index is preferably 1.52 or higher, possibly 1.54 or higher, 1.56 or higher, or even 1.58 or higher. According to the PSA sheet having such a refractive index, in an embodiment applied to a material having a high refractive index, light reflection can be favorably reduced at the interface with the adherend. In some embodiments, the refractive index is 1.60 or higher, or can be even 1.62 or higher. According to the PSA sheet having such a refractive index, in an embodiment applied to a material having a higher refractive index, light reflection can be favorably reduced at the interface with the adherend. The maximum refractive index may vary depending on the adherend’s refractive index, etc. Thus, it is not limited to a specific range. For instance, it is 1.70 or lower, or can be even 1.66 or lower. The refractive index of the PSA sheet can be adjusted based on the PSA species, through the PSA components (e.g., the monomer composition of the polymer, typically the species of particles P_{HRI}, its amount used, placement, etc.).

In case of a double-faced PSA sheet having an adhesive face on each side, the refractive indices of the respective faces (respective adhesive faces, the first and second adhesive faces) may be the same or different. In an embodiment of the double-faced PSA sheet with the respective faces (respective adhesive faces) differing in refractive index, while one face (e.g., the first adhesive face) has an aforementioned refractive index, the other face (e.g., the second adhesive face) may have a refractive index below 1.50.

As used herein, the refractive index of the PSA sheet refers to the refractive index of the PSA sheet surface (adhesive face). The refractive index of a PSA sheet can be determined at 23° C., using a commercial refractometer (a multi-wavelength Abbe refractometer or spectroscopic ellipsometer). As the multi-wavelength Abbe refractometer, for instance, model DR-M2 available from ATAGO Co., Ltd. or a comparable product is used. As the spectroscopic ellipsometer, for instance, product name EC-400 (available from J.A. Woollam Company) or a comparable product is used. In particular, the refractive index of the PSA sheet can be determined by the method described later in Examples. In the refractive index determination method, 589 nm wavelength light is used; however, this does not limit the refractive index range to which the technical ideas perceived from this Description is applied. In the art disclosed herein, the concept of refractive index includes a refractive index of light in a specific wavelength range selected in the visible light range (380 nm to 780 nm), and may further include a refractive index of light in a specific wavelength range selected in the UV range (380 nm or shorter, e.g., 100 nm to 380 nm) and IR range (780 nm or longer, e.g., 780 nm to 2500 nm).

### Total Light Transmittance

The total light transmittance of the PSA sheet disclosed herein can be selected depending on the purpose and application, and thus is not limited to a specific range. The total light transmittance can be, for instance, 80% or lower. With the total light transmittance limited up to the prescribed value, it is possible to adjust the adherend appearance through the PSA sheet (e.g., reduce unevenness in the adherend appearance) and provide design features. The total light transmittance is, for instance, below 80%. From the standpoint of enhancing the light-blocking properties, it can be 75% or lower, 70% or lower, 65% or lower, or even 60% or lower (e.g., 55% or lower). The minimum total light transmittance is not particularly limited. It can be 0%, that is, at or below detection limit. From industrial viewpoints including retention of adhesive properties, ease of manufacturing and efficiency, the total light transmittance can be above 0.01% (e.g., above 0.05%), even above 0.1%, 1% or higher, for instance, 3% or higher, or even about 5% or higher.

In some embodiments, the PSA sheet has a total light transmittance of higher than 10% and 80% or lower. The PSA sheet with such light transmission allows adjustment to the adherend appearance through the PSA sheet, for instance, reduction of unevenness in the adherend appearance. It also allows addition of design features with suitably limited light transmission. It can further have light-blocking properties as well as adherend visibility for inspection, etc. In this embodiment, the total light transmittance is, for instance, below 80%. For greater light-blocking properties, it is preferably 75% or lower, more preferably 70% or lower, yet more preferably 65% or lower, or possibly even 60% or lower (e.g., 55% or lower). From the standpoint of the visibility and designability through the PSA sheet, etc., the total light transmittance can be 20% or higher, 30% or higher, 50% or higher (e.g., above 50%), or even above 60%.

In other embodiments, the PSA sheet has a total light transmittance of 10% or lower. Such a PSA sheet may have light-blocking properties suited for preventing light leakage and reflection. In this embodiment, the total light transmittance of the PSA sheet can be below 10%. In some preferable embodiments, the PSA sheet has a total light transmittance below 8.0%, possibly below 6.0%, below 3.0%, more preferably below 1.00%, yet more preferably below 0.50%, or particularly preferably below 0.30% (e.g., below 0.10%). The PSA sheet showing such a total light transmittance can bring about excellent light-blocking properties. The minimum total light transmittance is not particularly limited and can be essentially 0%, that is, at or below detection limit.

The total light transmittance of the PSA sheet can be determined by the method described later in Examples. The total light transmittance of the PSA sheet can be adjusted through the PSA components (components of the PSA; preferably the species and amount used of particles, favorably pigments, etc.), placement of a colored layer, etc.

### Adhesive Strength

The 180° peel strength (adhesive strength) of the PSA sheet disclosed herein may vary depending on the purpose and application area and thus is not limited to a specific range. The PSA sheet may have an adhesive strength of, for instance, 0.3 N/10 mm or greater. From the standpoint of obtaining good adhesion to adherends, the 180° peel strength is suitably about 1.0 N/10 mm or greater, preferably about 2.0 N/10 mm or greater, or more preferably about 3.0 N/10 mm or greater. Such a PSA sheet can achieve both impact resistance and adhesion. In some embodiments, for instance, such an adhesive strength can be achieved while obtaining a prescribed or higher refractive index with the inclusion of particles P_{HRI}. In some embodiments, for instance, such an adhesive strength can be achieved while obtaining a prescribed or lower total light transmittance with the inclusion of carbon black particles. From the standpoint of the stability of bonding to adherends, the adhesive strength can be about 4.0 N/10 mm or greater, or even about 5.0 N/10 mm or greater (e.g., about 6.0 N/10 mm or greater). The maximum adhesive strength is not particularly limited and is, for instance, 12 N/10 mm or less, or possibly 8 N/10 mm or less (e.g., 5 N/10 mm or less). The 180° peel strength can be determined by the method described later in Examples.

### PSA Layer

### Base Polymer

In the art disclosed herein, the type of the PSA constituting the PSA layer is not particularly limited. The PSA layer may comprise, as adhesive polymer (or “base polymer” hereinafter, meaning a structural polymer that forms the PSA), one, two or more species among various rubber-like polymers such as acrylic polymer, rubber-based polymer (natural rubber, synthetic rubber, a mixture of these, etc.), polyester-based polymer, urethane-based polymer, polyether-based polymer, silicone-based polymer, polyamide-based polymer, and fluoropolymer that can be used in the PSA field. From the standpoint of the adhesive properties, cost, etc., a preferable PSA comprises an acrylic polymer or a rubber-based polymer as the base polymer. In particular, an acrylic PSA (a PSA whose base polymer is an acrylic polymer) is preferable. In the following, a PSA sheet having an acrylic PSA layer (i.e., a PSA layer formed of an acrylic PSA) is mainly described; however, the PSA layer in the PSA sheet disclosed herein is not to be limited to those formed of acrylic PSA. By applying the art disclosed herein, an acrylic PSA having a refractive index of 1.50 or higher can be favorably obtained.

In the following, a PSA sheet having an acrylic PSA layer (i.e., a PSA layer formed of an acrylic PSA) is mainly described; however, the PSA layer in the PSA sheet disclosed herein is not to be limited to those formed of acrylic PSA.

The “base polymer” of a PSArefers to a rubber-like polymer in the PSA. Besides this, it is not limited to a particular interpretation. The rubber-like polymer refers to a polymer that shows rubber elasticity around room temperature. As used herein, the “main component” (primary component) refers to a component accounting for more than 50% by weight.

The “acrylic polymer” refers to a polymer that includes a monomeric unit derived from a monomer having at least one (meth)acryloyl group per molecule. Hereinafter, a monomer having at least one (meth)acryloyl group per molecule is referred to as an “acrylic monomer.” Thus, as used herein, the acrylic polymer is defined to be a polymer that includes a monomeric unit derived from an acrylic monomer. Typical examples of the acrylic polymer include an acrylic polymer in which the acrylic monomer accounts for more than 50% by weight of all monomers used in synthesizing the acrylic polymer.

As used herein, the term “(meth)acryloyl” is meant to be inclusive of acryloyl and methacryloyl. Likewise, “(meth)acrylate” means acrylate and methacrylate, and “(meth)acryl” is meant to be inclusive of acryl and methacryl respectively.

### Acrylic Polymer

A preferable example of the acrylic polymer in the art disclosed herein is a polymer formed from a starting monomer mixture that comprises an alkyl (meth)acrylate as the primary monomer. Here, the primary monomer refers to a component that accounts for more than 50% by weight of the monomer composition of the starting monomer mixture.

For example, a compound represented by the following formula (1) can be advantageously used as the alkyl (meth)acrylate.

$${\text{CH}}_{2} {\text{=C(R}}^{1} {\text{)COOR}}^{2} \qquad \text{(1)}$$

Here, R¹ in the formula (1) is a hydrogen atom or a methyl group. R² is an acyclic alkyl group having 1 to 20 carbon atoms (hereinafter such a range of the number of carbon atoms may be expressed as “C₁₋₂₀”). From the standpoint of the storage elastic modulus of the PSA and the like, the primary monomer is suitably an alkyl (meth)acrylate in which R² is a acyclic C₁₋₁₄ (e.g., C₂₋₁₀, typically C₄₋₈) alkyl group. From the standpoint of the adhesive properties, the primary monomer is preferably an alkyl acrylate in which R¹ is a hydrogen atom and R² is an acyclic C₄₋₈ alkyl group (which may also be simply referred to as a C₄₋₈ alkyl acrylate).

Specific examples of the alkyl (meth)acrylate having a C₁₋₂₀ acyclic alkyl group for R² include, but are not limited to, methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, and eicosyl (meth)acrylate. These alkyl (meth)acrylates can be used singly as one species or in a combination of two or more species. Favorable examples of the alkyl (meth)acrylate include n-butyl acrylate (BA) and 2-ethylhexyl acrylate (2EHA).

Typically, the amount of the alkyl (meth)acrylate among the monomeric components constituting the acrylic polymer is more than 50% by weight, for example 70% by weight or more, may be 85% by weight or more, or may be even 90% by weight or more. The maximum percent alkyl (meth)acrylate is not particularly limited. It is preferably 99.5% by weight or less (e.g., 99% by weight or less); or from the standpoint of preferably obtaining properties (e.g., cohesive strength) based on a secondary monomer such as a carboxy group-containing monomer, it may be 98% by weight or less (e.g., less than 97% by weight). Alternatively, the acrylic polymer may be a polymer essentially formed of an alkyl (meth)acrylate.

When using a C₄₋₈ alkyl acrylate as a monomer, of the alkyl (meth)acrylate content of the monomers, the C₄₋₈ alkyl acrylate accounts for preferably 70% by weight or more, or more preferably 90 % by weight or more. The art disclosed herein can be preferably implemented in an embodiment in which BA accounts for at least 50% (typically at least 60%) by weight of all monomers. In some preferable embodiments, of all monomers, BA may account for 70% by weight or more, 80% by weight or more, or even 90% by weight or more. The monomers may further comprise 2EHA in a lower proportion than BA.

The art disclosed herein can be preferably implemented in an embodiment in which the starting monomer mixture includes at least 50% C₁₋₄ alkyl (meth)acrylate by weight. The ratio of C₁₋₄ alkyl (meth)acrylate in the monomers may be 70% by weight or higher, or may be 85% by weight or higher (e.g., 90% by weight or higher). On the other hand, from the standpoint of obtaining good cohesive strength, the ratio of C₁₋₄ alkyl (meth)acrylate in the starting monomers is suitably 99.5% by weight or lower, and this amount may be 98% by weight or lower (for example, 97% by weight or lower).

The art disclosed herein can be preferably implemented in an embodiment in which the C₂₋₄ alkyl acrylate accounts for 50% by weight or more (e.g., 70% by weight or more, 85% by weight or more, or 90% by weight or more) of the monomers. Specific examples of the C₂₋₄ alkyl acrylate include ethyl acrylate, propyl acrylate, isopropyl acrylate, n-butyl acrylate (BA), isobutyl acrylate, s-butyl acrylate, and t-butyl acrylate. The C₂₋₄ alkyl acrylates can be used singly as one species or in a combination of two or more species. According to such an embodiment, the resulting PSA sheet is likely to show tight adhesion to an adherend. In preferable embodiments, BA accounts for more than 50 % by weight (e.g., 70% by weight or more, or 85% by weight or more, or 90% by weight or more) of the monomers. When the C₂₋₄ alkyl acrylate (e.g., BA) is used at least in a prescribed amount, for instance, even if a black colorant (e.g., carbon black) is added to the PSA, the colorant can be well dispersed in the layer while maintaining good levels of adhesive properties such as adhesive strength. From the standpoint of obtaining satisfactory cohesive strength, the ratio of C₂₋₄ alkyl (meth)acrylate in the monomers is suitably 99.5% by weight or lower, or possibly 98% by weight or lower (e.g., below 97% by weight).

In some embodiments, the starting monomer mixture may include at least 50% (e.g., at least 70%, at least 85% or at least 90%) C₅₋₂₀ alkyl (meth)acrylate by weight. A preferable C₅₋₂₀ alkyl (meth)acrylate is a C₆₋₁₄ alkyl (meth)acrylate. In some embodiments, a C₆₋₁₀ alkyl acrylate (e.g., a C₈₋₁₀ alkyl acrylate) can be preferably used.

A secondary monomer may be copolymerized in the acrylic polymer in the art disclosed herein. Secondary monomers can introduce functional groups capable of constituting cross-linking points in the acrylic polymer or can contribute to increasing adhesive strength. Examples of such secondary monomers include carboxy group-containing monomers, hydroxyl group (OH group)-containing monomers, acid anhydride group-containing monomers, amide group-containing monomers, amino group-containing monomers, epoxy group-containing monomers, cyano group-containing monomers, keto group-containing monomers, monomers having a nitrogen atom-containing ring, alkoxysilyl group-containing monomers and imide group-containing monomers. For the secondary monomer, solely one species or a combination of two or more species can be used.

A preferable example of the acrylic polymer in the art disclosed herein is an acrylic polymer in which a carboxy group-containing monomer is copolymerized as the secondary monomer. Examples of the carboxy group-containing monomer include acrylic acid (AA), methacrylic acid (MAA), carboxyethyl (meth)acrylate, carboxypentyl (meth)acrylate, itaconic acid, maleic acid, fumaric acid, crotonic acid, and isocrotonic acid. In particular, AA and MAA are preferable.

Other favorable examples include an acrylic polymer in which a hydroxy group-containing monomer is copolymerized as the secondary monomer. Examples of hydroxy group-containing monomers include hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, and 4-hydroxybutyl (meth)acrylate; polypropylene glycol mono (meth)acrylate; and N-hydroxyethyl (meth)acrylamide. A particularly preferable hydroxy group-containing monomer is a hydroxyalkyl (meth)acrylate having a linear alkyl group with 2 to 4 carbon atoms.

Examples of amide group-containing monomers include (meth)acrylamide, N,N-dimethyl (meth)acrylamide, N-butyl (meth)acrylamide, N-methylol (meth)acrylamide, N-methylolpropane (meth)acrylamide, N-methoxymethyl (meth)acrylamide, and N-butoxymethyl (meth)acrylamide.

Examples of amino group-containing monomers include aminoethyl (meth)acrylate, N,N-dimethylaminoethyl (meth)acrylate, and t-butylaminoethyl (meth)acrylate.

Examples of epoxy group-containing monomers include glycidyl (meth)acrylate, methylglycidyl (meth)acrylate, and allyl glycidyl ether.

Examples of cyano group-containing monomers include acrylonitrile and methacrylonitrile.

Examples of keto group-containing monomers include diacetone (meth)acrylamide, diacetone (meth)acrylate, vinyl methyl ketone, vinyl ethyl ketone, allyl acetoacetate, and vinyl acetoacetate.

Examples of monomers having a nitrogen atom-containing ring include N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-vinylmorpholine, N-vinylcaprolactam, and N-(meth)acryloylmorpholine.

Examples of alkoxysilyl group-containing monomers include 3-(meth)acryloxypropyltrimethoxysilane, 3-(meth)acryloxypropyltriethoxysilane, 3-(meth)acryloxypropylmethyldimethoxysilane, and 3-(meth)acryloxypropylmethyldiethoxysilane.

When the monomers forming the acrylic polymer include an aforementioned functional group-containing monomer, the amount of the functional group-containing monomer among the monomeric components is not particularly limited. From the standpoint of suitably exhibiting the effect of using the functional group-containing monomer, the amount of the functional group-containing monomer among the monomeric components can be, for example, 0.1% by weight or more, a suitable amount is 0.5% by weight or more, and this amount may be 1% by weight or more. From the standpoint of facilitating the balance of adhesive performance in relation to the primary monomer, a suitable amount of the functional group-containing monomer among the monomeric components is 40% by weight or less, and this amount is preferably 20% by weight or less, or may be 10% by weight or less (e.g., 5% by weight or less).

In the base polymer according to some preferable embodiments, the monomers forming the base polymer (e.g., acrylic polymer) may include a carboxy group-containing monomer. The monomers including the carboxy group-containing monomer are likely to result in a PSA sheet showing good adhesive properties (cohesive strength, etc.). This can be advantageous in improving the tightness of adhesion between the PSA layer and the adherend. Furthermore, for instance, when a black colorant such as carbon black is added to the PSA, copolymerization of a carboxy group-containing monomer in a suitable amount facilitates dispersion of the colorant in the layer and the adhesive properties can be preferably retained.

In an embodiment in which a carboxy group-containing monomer is copolymerized in the base polymer, the amount of carboxy group-containing monomer in the monomers forming the base polymer is not particularly limited and it can be, for example, 0.2% by weight or more (typically 0.5% by weight or more) of the monomers. It is suitably 1% by weight or more or can be 2% by weight or more, or even 3% by weight or more. With more than 3% carboxy group-containing monomer by weight, a greater effect can be obtained. In some embodiments, the amount of carboxy group-containing monomer in the monomers can be 3.2% by weight or more, 3.5% by weight or more, 4% by weight or more, or even 4.5% by weight or more. The maximum amount of carboxy group-containing monomer is not particularly limited. For instance, it can be 15% by weight or less, 12% by weight or less, or even 10% by weight or less. The art disclosed herein can be preferably implemented in an embodiment in which the carboxy group-containing monomer content is 7% by weight or less (typically less than 7% by weight, e.g., 6.8% by weight or less, or 6.0% by weight or less).

The monomers forming the acrylic polymer may include other comonomer besides the secondary monomer for the purpose of improving the cohesiveness or the like. Examples of the other comonomer include vinyl ester monomers such as vinyl acetate, vinyl propionate, and vinyl laurate; aromatic vinyl compounds such as styrene, substituted styrene (α-methylstyrene and the like), and vinyl toluene; cycloalkyl (meth)acrylates such as cyclohexyl (meth)acrylate, cyclopentyl (meth)acrylate, and isobomyl (meth)acrylate; aromatic ring-containing (meth)acrylates such as aryl (meth)acrylates (e.g., phenyl (meth)acrylate), aryloxyalkyl (meth)acrylates (e.g., phenoxyethyl (meth)acrylate), and arylalkyl (meth)acrylates (e.g., benzyl (meth)acrylate); olefinic monomers such as ethylene, propylene, isoprene, butadiene, and isobutylene; chlorine-containing monomers such as vinyl chloride and vinylidene chloride; isocyanate group-containing monomers such as 2-(meth)acryloyloxyethyl isocyanate; alkoxy group-containing monomers such as methoxyethyl (meth)acrylate and ethoxyethyl (meth)acrylate; vinyl ether monomers such as methyl vinyl ether and ethyl vinyl ether; and polyfunctional monomers having two or more (e.g., three or more) polymerizable functional groups (e.g., (meth)acryloyl groups) in a molecule, such as 1,6-hexanediol di(meth)acrylate and trimethylolpropane tri(meth)acrylate.

The amount of such other comonomer is not particularly limited and may be suitably selected according to the purpose and application. From the standpoint of suitably obtaining the effect of the use thereof, a suitable amount is 0.05% by weight or more, and this amount may be 0.5% by weight or more. From the standpoint of facilitating the balance of the PSA performance, a suitable amount of the other copolymerizable component among the monomeric components is 20% by weight or less, and this amount may be 10% by weight or less (e.g., 5% by weight or less). The art disclosed herein also can be preferably implemented in an embodiment in which the monomeric components include substantially no other copolymerizable components. Here, the expression that the monomeric components include substantially no other copolymerizable monomers means that no other copolymerizable monomers is used at least intentionally. For example, it may be permitted that about 0.01% by weight or less of other copolymerizable monomers is included unintentionally.

The copolymer composition of the acrylic polymer can be suitably designed so that the polymer has a glass transition temperature (Tg) of about -15° C. or below (e.g., about -70° C. or above and -15° C. or below). Here, the acrylic polymer’s Tg refers to the Tg value determined by the Fox equation based on the composition of the monomers used in the synthesis of the polymer. As shown below, the Fox equation is a relational expression of the Tg of a copolymer and the glass transition temperatures Tgi of the homopolymers obtained by homopolymerization of the monomers constituting the copolymer.

$$1 \text{/Tg =} \sum \left(\text{Wi/Tgi}\right)$$

In the Fox equation above, Tg represents the glass transition temperature (unit: K) of the copolymer, Wi the weight fraction (copolymerization ratio by weight) of a monomer i in the copolymer, and Tgi the glass transition temperature (unit: K) of the homopolymer of the monomer i.

As for the glass transition temperatures of homopolymers used in Tg determination, values disclosed in publicly known resources are used. For instance, with respect to the monomers listed below, as the glass transition temperatures of their corresponding homopolymers, the following values are used.

| | |
|---|---|
| 2-ethylhexyl acrylate | -70° C. |
| isononyl acrylate | -60° C. |
| n-butyl acrylate | -55° C. |
| ethyl acrylate | -22° C. |
| methyl acrylate | 8° C. |
| methyl methacrylate | 105° C. |
| 2-hydroxyethyl acrylate | -15° C. |
| 4-hydroxybutyl acrylate | -40° C. |
| vinyl acetate | 32° C. |
| acrylic acid | 106° C. |
| methacrylic acid | 228° C. |

With respect to the Tg values of the homopolymers of other monomers besides those exemplified above, the values given in “Polymer Handbook” (3rd edition, John Wiley & Sons, Inc., Year 1989) are used. When the Polymer Handbook provides two or more values for a certain monomer, the highest value is used. In the case where the values are not described in the Polymer Handbook, those that can be obtained by the measuring method described in Japanese Patent Application Publication No. 2007-51271 is used.

While no particular limitations are imposed, from the standpoint of the impact resistance and tightness of adhesion to an adherend, the Tg of the acrylic polymer is advantageously about -25° C. or lower, preferably about -35° C. or lower, and more preferably about -40° C. or lower, but these values are not particularly limiting. In some embodiments, from the standpoint of cohesiveness, the Tg of the acrylic polymer may be, for example, about -65° C. or higher, about -60° C. or higher, or about -55° C. or higher. The art disclosed herein can be preferably implemented in an embodiment in which the Tg of the acrylic polymer is about -65° C. or higher and about -35° C. or lower (e.g., about -55° C. or higher and about -40° C. or lower). The Tg of the acrylic polymer can be adjusted by suitably changing the monomer composition (that is, the type of monomers used for synthesizing the polymer and the ratio of the amounts used).

The method for obtaining the acrylic polymer is not particularly limited. Various polymerization methods known as synthetic means for acrylic polymers can be suitably employed, with the methods including solution polymerization method, emulsion polymerization, bulk polymerization, suspension polymerization, and photopolymerization. For example, a solution polymerization method can be preferably used. The polymerization temperature in the solution polymerization can be suitably selected according to the types of monomers and solvent to be used, the type of polymerization initiator, and the like. It can be, for example, about 20° C. to 170° C. (typically, about 40° C. to 140° C.).

As for the solvent (polymerization solvent) used in solution polymerization, a suitable species can be selected among heretofore known organic solvents. For instance, one species of solvent or a mixture of two or more species of solvent can be used, selected among aromatic compounds (typically aromatic hydrocarbons) such as toluene; acetic acid esters such as ethyl acetate; aliphatic or alicyclic hydrocarbons such as hexane and cyclohexane; halogenated alkanes such as 1,2-dichloroethane; lower alcohols (e.g., monohydric alcohols with one to four carbon atoms) such as isopropanol; ethers such as tert-butyl methyl ether; and ketones such as methyl ethyl ketone.

The initiator used for polymerization can be suitably selected among heretofore known polymerization initiators according to the type of polymerization method. For example, one or two or more species of azo polymerization initiators such as 2,2′-azobisisobutyronitrile (AIBN) can be preferably used. Other examples of the polymerization initiator include persulfates such as potassium persulfate; peroxide initiators such as benzoyl peroxide and hydrogen peroxide; substituted ethane initiators such as phenyl-substituted ethane; and aromatic carbonyl compounds. Still other examples of the polymerization initiator include redox type initiators based on a combination of a peroxide and a reducing agent. Such polymerization initiators can be used singly as one species or in a combination of two or more species. The polymerization initiator can be used in a typical amount, for example, about 0.005 part to 1 part by weight (typically, about 0.01 part to 1 part by weight) to 100 parts by weight of the monomers.

The solution polymerization yields a polymerization reaction mixture as a solution of acrylic polymer in an organic solvent. The PSA layer in the art disclosed herein may be formed from a PSA composition comprising the polymerization reaction mixture or an acrylic polymer solution obtained by subjecting the reaction mixture to a suitable work-up. For the acrylic polymer solution, the polymerization reaction mixture can be used after adjusted to suitable viscosity and/or concentration as necessary. Alternatively, an acrylic polymer can be synthesized by a polymerization method other than solution polymerization, such as emulsion polymerization, photopolymerization, bulk polymerization, etc., and an acrylic polymer solution prepared by dissolving the acrylic polymer in an organic solvent can be used as well.

The weight average molecular weight (Mw) of the base polymer (preferably acrylic polymer) in the art disclosed herein is not particularly limited, and may be, for example, in the range of about 10 × 10⁴ to 500 × 10⁴. From the standpoint of the adhesive properties, the Mw of the base polymer is in the range of about 30 × 10⁴ to 200 × 10⁴ (more preferably, about 45 × 10⁴ to 150 × 10⁴, typically about 65 × 10⁴ to 130 × 10⁴). Here, Mw refers to a value obtained based on polystyrene standards by gel permeation chromatography (GPC). As the GPC apparatus, for example, model name “HLC-8320 GPC” (column: TSK gel GMH-H (S), available from Tosoh Corporation) can be used.

### Particles P_{HRI}

The PSA disclosed herein may typically comprise particles P_{HRI}. The particles P_{HRI} are particles capable of increasing the refractive index of a PSA (layer), with HRI standing for high refractive index. In that sense, particles P_{HRI} can be paraphrased as high-refractive-index particles. With the particles P_{HRI} in the PSA layer, a PSA sheet having a refractive index of 1.50 or higher can be prepared. For instance, by adjusting the particle size and the amount included, the total light transmittance of the PSA sheet can be reduced. As the particles P_{HRI}, solely one species or a combination of two or more species can be used.

As the particle P_{HRI}, it is possible to use various materials capable of increasing the PSA layer’s refractive index to 1.50 or higher. Known general PSAs have refractive indices lower than 1.50 (e.g., about 1.47). With respect to a PSA having such a compositional basis, for instance, when the PSA layer includes a suitable amount of particles formed of a material having a refractive index higher than 1.50, the refractive index of the PSA sheet can be increased. As the particles P_{HRI}, it is possible to use one, two or more species of particles formed from a material having a refractive index of, for instance, 1.60 or higher, preferably 1.70 or higher, more preferably 1.80 or higher, or yet more preferably 2.00 or higher (e.g., 2.20 or higher). The maximum refractive index of the material forming the particles P_{HRI} (or “P_{HRI}forming material” hereinafter) is not particularly limited. From the standpoint of the ease of handling in view of the compatibility with the PSA, it is, for instance, 3.00 or lower, possibly 2.80 or lower, 2.50 or lower, or even 2.20 or lower. The refractive index of the P_{HRI}-forming material is determined for a single layer of the material (with a refractometrically-analyzable layer thickness) at 23° C. using a commercial spectroscopic ellipsometer. The applicable wavelength range is the same as the PSA sheet’s refractive index. As the spectroscopic ellipsometer, for instance, product name EC-400 (J.A. Woollam Company) or a comparable product is used.

The species of particles P_{HRI} is not particularly limited. One, two or more species of materials capable of increasing the PSA sheet’s refractive index can be used among metal particles, metal compound particles, organic particles, and organic/inorganic composite particles. As the particles P_{HRI}, it is preferable to use a species capable of increasing the PSA sheet’s refractive index among inorganic oxides (e.g., metal oxides). Favorable examples of the P_{HRI}-forming material include inorganic oxides (specifically, metal oxides) such as titania (titanium oxide, TiO₂), zirconia (zinc oxide, ZrO₂), cerium oxide, aluminum oxide, zinc oxide, tin oxide, copper oxide, barium titanate and niobium oxide (Nb₂O₅, etc.). Among particles formed of these inorganic oxides (e.g., metal oxides), solely one species or a combination of two or more species can be used. In particular, particles formed of titania or zirconia are preferable, and particles formed of zirconia are particularly preferable. As the metal particles, for instance, iron-based, zinc-based, tungsten-based and platinum-based materials may have high refractive indices. As for the organic particles, particles formed of resins such as a styrene-based resin, phenol resin, polyester-based resin and polycarbonate-based resin have relatively high refractive indices. Examples of the organic/inorganic composite particles include particles of a composite of aforementioned inorganic and organic materials, and inorganic particles coated with an organic material such as a resin. The particles P_{HRI} does not comprise carbon black particles and can be defined as particles different from carbon black particles. Typically, the particles P_{HRI} are free of a light-absorbing black colorant.

In view of the compatibility with adhesive components, as the particles P_{HRI}, it is preferable to use particles obtained by subjecting aforementioned organic and/or inorganic particles to a surface treatment with a surface treatment agent. Such a surface treatment can effectively improve the compatibility of nano-sized particles having a mean particle size of less than 1 µm. As the surface treatment, a suitable treatment can be selected in accordance with the species of core particles, the kind of dispersion medium, etc.; and therefore, it is not limited to a specific treatment. The surface treatment typically allows the surface treatment agent to modify core particles (e.g., inorganic particles such as a metal oxide). The surface treatment agent can be a compound that has a functional group (carboxyl group, sulfonate group, phosphate group, hydroxy group, amino group, isocyanate group, vinyl group, alkoxysilyl group, etc.) reactive towards core particles (e.g., inorganic particles such as a metal oxide) and further has an aliphatic group, alicyclic group, aromatic group or other organic group such as an alkyl group, alkenyl group, (meth) acryloyl group and phenyl group. Because the organic group has a certain level of hydrophobicity (lipophilicity), the surface of core particles (e.g., inorganic particles such as a metal oxide) can be hydrophobized by the surface treatment to be highly compatible (mix well) with adhesive components including a polymer such as an acrylic or rubber-based polymer. Such a surface treatment can be referred to as a hydrophobic surface treatment (hydrophobization). By a preferable surface treatment, reactive groups such as alkenyl groups and (meth)acryloyl groups may constitute the surface of particles P_{HRI}. Examples of the surface treatment agent include organic acids such as aliphatic carboxylic acids; surfactants (including reactive surfactants having reactive functional groups) such as anionic surfactants (sulfonate-based, phosphate-based, fatty acid-based, etc.); functional group-containing (meth) acrylates; silane compounds such as silane coupling agents and alkoxysilanes; siloxane compounds; silazane compounds; and titanium coupling agents. These surface treatment agents may be used singly as one species or in a combination of two or more species. The surface treatment agent is used in surface treatment of core particles, employing a suitable method and conditions (amount of surface treatment agent used, use/nonuse of reaction aid, solvent, temperature, time, etc.) known to a skilled person.

In some preferable embodiments, for the core particles (e.g., inorganic particles of a metal oxide, etc.) of particles P_{HRI}, a surface treatment (hydrophobization) using a sulfonate-based compound can be employed. Possible sulfonate-based compounds for use include sulfonate-based surfactants such as alkylbenzene sulfonates such as nonylbenzene sulfonate and dodecylbenzene sulfonate; naphthalene sulfonates such as dodecylnaphthalene sulfonate; and alkyldiphenyl ether disulfonates such as dodecyldiphenyl ether disulfonate. As the sulfonate-based compound, solely one species or a combination of two or more species can be used.

In other embodiments, for the core particles (e.g., inorganic particles of a metal oxide, etc.) of particles P_{HRI}, the applicable surface treatment (hydrophobization) may use a carboxyl group-containing compound (a saturated or unsaturated aliphatic carboxylic acid, methacrylic acid, etc.) as the surface treatment agent. In some other embodiments, the applicable surface treatment (hydrophobization) may use an isocyanate group-containing (meth)acrylate such as methacryloyloxyethyl isocyanate (MOI) or a polyfunctional (meth)acrylate such as dipentaerythritol hexaacrylate (DPHA) as the surface treatment agent. In yet other embodiments, the applicable surface treatment (hydrophobization) may use a vinyl group-containing alkoxysilane such as vinyltrimethoxysilane (VTMS) or a silane compound such as (meth)acryloyl group-containing alkoxysilane as the surface treatment agent.

To the PSA composition, the particles P_{HRI} can be added, for instance, as a dispersion of surface-treated particles. The dispersion medium of the dispersion is not particularly limited. A suitable dispersion medium can be used in view of the dispersibility of particles P_{HRI} in the PSA layer. From the standpoint of the dispersibility of particles P_{HRI} in the PSA layer, an organic solvent is preferably used. Examples of the dispersion medium include alcohols such as methanol, ethanol, isopropanol and ethylene glycol; ketones such as acetone, methyl ethyl ketone (MEK), methyl isobutyl ketone, methyl propyl ketone (MPK), cyclohexanone and cyclopentanone; ethers such as diethyl ether, tetrahydrofuran, dioxane, anisole, propylene glycol monomethyl ether (PGME) and propylene glycol monomethyl ether acetate; esters such as ethyl acetate, butyl acetate and methyl lactate; aromatic hydrocarbons such as benzene, toluene and xylene; aliphatic hydrocarbons such as n-hexane and cyclohexane; amides such as dimethylformamide and dimethylacetamide (DMA); and cellosolves such as methyl cellosolve, ethyl cellosolve and butyl cellosolve. These organic solvents may be used singly as one species or as a mixture of two or more species. Among them, ketones and amides are preferable; methyl ethyl ketone, methyl isobutyl ketone and dimethylacetamide are more preferable; and dimethylacetamide is yet more preferable. From the standpoint of the compatibility with adhesive components (e.g., components of acrylic PSA), it is preferable to not use alcohols or ethers. The concentration of particles P_{HRI} in the particle P_{HRI}-containing dispersion is not particularly limited. For good ease of dispersion into the PSA layer, it is about 1% to 50% (e.g., 15% to 35%) by weight.

The mean particle diameter of particles P_{HRI} is not particularly limited. Particles having a suitable size capable of desirably increasing the refractive index can be used in accordance with the PSA layer thickness, PSA species, etc. The particles P_{HRI} have a mean particle diameter of, for instance, possibly about 1 nm or greater, or suitably about 5 nm or greater. From the standpoint of the refractive index enhancement, compatibility, handling properties, etc., the particles P_{HRI} have a mean particle diameter of preferably about 10 nm or greater, possibly about 20 nm or greater, or even about 30 nm or greater. From the standpoint of retaining adhesive properties, etc., the maximum mean particle diameter is suitably, for instance, about 300 nm or less. For increasing the refractive index, it is preferably about 100 nm or less, more preferably about 70 nm or less, yet more preferably about 50 nm or less, or possibly even about 35 nm or less (e.g., about 25 nm or less).

The mean particle diameter of particles P_{HRI} refers to the median volume diameter, in particular, the particle diameter at the 50th percentile (the 50th-percentile particle diameter, which may be abbreviated as D₅₀ hereinafter) in a size distribution obtained with respect to a dispersion of particles P_{HRI} using a particle size meter based on laser scattering/diffraction. As the analyzer, for instance, product name MICROTRAC MT3000II available from MicrotracBEL Corporation or a comparable product can be used.

The particle P_{HRI} content of the PSA layer is not particularly limited. The particle P_{HRI} content may vary depending on the target refractive index of the PSA sheet. For instance, the particle P_{HRI} content can be suitably selected to obtain a prescribed or higher refractive index in view of the required adhesive properties, etc. The particle P_{HRI} content may also vary depending on the PSA species, particle diameters of particles P_{HRI}, compatibility with the PSA, etc. The particle P_{HRI} content in the PSA layer can be about 1% by weight or higher, or even about 10% by weight or higher. From the standpoint of effectively increasing the refractive index of the PSA sheet, the particle P_{HRI} content is suitably about 20% by weight or higher (e.g., above 20% by weight), preferably about 25% by weight or higher, more preferably about 30% by weight or higher, yet more preferably about 35% by weight or higher, particularly preferably about 40% by weight or higher, or possibly even about 45% by weight or higher. From the standpoint of the compatibility with adhesive components, retention of adhesive properties such as adhesive strength and impact resistance, etc., the particle P_{HRI} content in the PSA layer is possibly about 75% by weight or lower, about suitably 60% by weight or lower, preferably about 50% by weight or lower, or possibly even about 40% by weight or lower.

The particle P_{HRI} content of the PSA layer can also be specified in relation to the base polymer (e.g., acrylic polymer) of the PSA. The particle P_{HRI} content to 100 parts by weight of the base polymer is possibly about 1 part by weight or greater, suitably about 10 parts by weight or greater, or possibly even about 30 parts by weight or greater (e.g., greater than 30 parts by weight). From the standpoint of increasing the refractive index of the PSA sheet, the particle P_{HRI} content to 100 parts by weight of the base polymer is preferably about 50 parts by weight or greater, more preferably about 70 parts by weight or greater, or yet more preferably about 90 parts by weight or greater. From the standpoint of the compatibility with adhesive components, retention of adhesive properties such as adhesive strength and impact resistance and so on, the particle P_{HRI} content to 100 parts by weight of the base polymer is, for instance, suitably about 200 parts by weight or less, preferably about 170 parts by weight or less, more preferably about 140 parts by weight or less, or yet more preferably 120 parts by weight or less.

### Particle Diameter Properties of Particles P_{HRI} in PSA Layer

While no particular limitations are imposed, in an embodiment where the PSA layer comprises particles P_{HRI}, the particles P_{HRI} present in the PSA layer may have a mean particle diameter of, for instance, less than 300 nm. Here, the mean particle diameter of the particles P_{HRI} present in the PSA layer refers to the mean particle diameter determined based on a number-based particle size distribution by TEM analysis. In particular, it is determined using a frozen ultrathin section of the PSA. That the particles P_{HRI} in the PSA layer have a mean particle diameter of less than 300 nm may indicate that a certain amount of particles P_{HRI} are compatibly well-mixed. By this, the effect of using particles P_{HRI} to increase the PSA layer’s refractive index can be effectively obtained. The mean particle diameter is suitably less than 100 nm, less than preferably 80 nm, more preferably less than 60 nm, yet more preferably less than 40 nm, or possibly even less than 30 nm. The minimum mean particle diameter is not particularly limited. It is suitably about 1 nm or greater. From the standpoint of favorably obtaining a refractive index increase, it is preferably about 5 nm or greater, more preferably about 10 nm or greater, or yet more preferably about 20 nm or greater. The particles P_{HRI} having a mean particle diameter in an aforementioned range in the PSA layer are present, typically dispersed in the PSA layer. In other words, the PSA layer comprises adhesive components such as base polymer and the particle P_{HRI} may be dispersed in the PSA layer.

In the number-based particle size distribution by TEM, the particles P_{HRI} present in the PSA layer disclosed herein have a standard deviation (SD) of suitably less than 35 nm, or preferably 20 nm or less (e.g., less than 20 nm). By this, the effect of using particles P_{HRI} to increase the refractive index can be effectively obtained. The standard deviation is more preferably less than 15 nm, yet more preferably less than 10 nm, or particularly preferably less than 8 nm. The minimum standard deviation is not particularly limited. It can be about 1 nm or greater, for instance, about 2 nm or greater (typically about 3 nm or greater).

In the number-based particle size distribution by TEM, particles having particle diameters of 50 nm or greater suitably account for 5% or less of the particles P_{HRI} present in the PSA layer disclosed herein. The low percentage of large-diameter particles having particle diameters of 50 nm or greater may indicate a limited amount of agglomerates. Such an embodiment can more favorably bring about the effect of particles P_{HRI} compatibly well-mixed with the adhesive components. In the particle size distribution, the percentage of particles having particle diameters of 50 nm or greater is preferably 3% or lower.

While no particular limitations are imposed, in the number-based particle size distribution by TEM, the particles P_{HRI} present in the PSA layer preferably has a limited percentage of particles having particle diameters of less than 15 nm. This is because particles having particle diameters of less than 15 nm include small-diameter particles thought to insignificantly contribute to increasing the refractive index. From such a standpoint, in the particle size distribution, the percentage of particles having particle diameters of less than 15 nm is preferably about 30% or lower, more preferably about 20% or lower, or yet more preferably about 15% or lower. Considering the sort of difficulty in perfectly controlling particle size distributions, in the particle distribution, the percentage of particles having particle diameters of less than 15 nm can be about 1% or higher, for instance, 2% or higher (even about 3% or higher).

These mean particle diameter, standard deviation and other particle diameter distribution properties determined based on the number-based particle size distribution by TEM can be obtained through a selection of particle P_{HRI} species, PSA composition (mainly the base polymer’s monomer composition, species and amount of crosslinking agent, etc.), surface treatment for particles P_{HRI} suited for the PSA, a selection of species and amount of dispersant, formulation (dispersion, dispersion medium, etc.) and conditions for addition of particles P_{HRI} to the PSA composition, and so on. For instance, different species of particles P_{HRI}, surface treatment methods and adhesive components can be combined to prepare various PSA species for testing; and these PSA species can be screened by TEM (this process may be repeated if necessary) to obtain a particle P_{HRI}-containing PSA having a desirable particle diameter distribution. The species of particles P_{HRI} and the surface treatment method therefor can be selected in accordance with the properties of the particle P_{HRI}-containing PSA based on the content of this Description and common technical knowledge. The mean particle diameter, standard deviation and other particle diameter properties determined based on the number-based particle size distribution by TEM are determined, in particular, by the method described later in Examples.

### Colorant

The PSA layer can include a colorant. By this, the light transmission (light-blocking properties) of the PSA sheet can be adjusted. As the colorant, various materials can be used that can attenuate the light advancing inside the PSA layer by absorption. The colorant may have a color of, for instance, black, gray, red, blue, yellow, green, yellow-green, orange and purple. The PSA layer may include the colorant typically dispersed (possibly dissolved) in the components of the PSA layer. As the colorant, among heretofore known pigments and dyes, one, two or more species of materials capable of decreasing the total light transmittance can be used. The pigments include inorganic and organic pigments. Examples of the dyes include azo-based dyes, anthraquinone, quinophthalone, styryl, diphenylmethane, triphenylmethane, oxazine, triazine, xanthan, methane, azomethine, acridine, and diazine. The colorants can be used singly as one species or in a suitable combination of two or more species.

### Black Colorant

A black colorant can be preferably used because it allows efficient adjustment to the light-blocking properties in a small amount. Specific examples of the black colorant include carbon black, graphite, aniline black, perylene black, cyanine black, activated carbon, molybdenum disulfide, chromium complexes, and anthraquinone-based colorants. For the black colorant, solely one species or a suitable combination of two or more species can be used.

### Carbon Black Particles

In some preferable embodiments, the PSA layer comprises carbon black particles. As the carbon black particles for use, species generally called carbon black (furnace black, channel black, acetylene black, thermal black, lamp black, turpentine soot, etc.) can be used without particular limitations. As the carbon black particles, it is also possible to use surface-modified carbon black particles having a functional group such as carboxy group, amino group, sulfonate group and siliconcontaining group (e.g., alkoxysilyl group, alkylsilyl group). Such surface-modified carbon black particles are also called self-dispersible carbon black with which dispersant addition may be unnecessary or the amount added can be reduced. For the carbon black particles, solely one species or a combination of two or more species can be used.

In an embodiment where the PSA layer comprises carbon black particles, the amount of a non-carbon-black colorant (i.e., a colorant other than carbon black particles) in the PSA layer is not particularly limited. It is, for instance, possibly below 13% by weight, preferably below 10% by weight, also possibly, for instance, below 5% by weight, or even below 3.0% by weight (e.g., below 2.0 % by weight, or even below 1% by weight). The art disclosed herein can be preferably implemented in an embodiment in which the PSA layer is essentially free of a non-carbon-black colorant. As used herein, “essentially free of” means absence of deliberate addition. For instance, the amount in the PSA layer can be 0.3% by weight or less (e.g., 0.1% by weight or less, or typically 0.01% by weight or less).

A particulate colorant (pigment) can be preferably used because it allows efficient adjustment to the light-blocking properties in a small amount. In some preferable embodiments, a colorant (e.g., a particulate black colorant such as carbon black) having a mean particle diameter of about 10 nm or larger (e.g., about 30 nm or larger) can be used. The mean particle diameter can be, for instance, about 50 nm or greater, about 100 nm or greater, or even about 150 nm or greater. The maximum mean particle diameter of the colorant is not particularly limited. For instance, it is about 3000 nm or less, or possibly about 1000 nm or less. From the standpoint of increasing the light-blocking properties, the colorant’s mean particle diameter can be suitably about 500 nm or less, preferably about 300 nm or less, more preferably about 250 nm or less, or yet more preferably 200 nm or less (e.g., about 120 nm or less, or even about 100 nm or less).

Here, the mean particle diameter of a colorant refers to the median volume diameter, in particular, the particle diameter at the 50th percentile (the 50th-percentile particle diameter, which may be abbreviated as D₅₀ hereinafter) in its size distribution obtained by a particle size meter based on laser scattering/diffraction. As the analyzer, for instance, product name MICROTRAC MT3000II available from MicrotracBEL Corporation or a comparable product can be used.

In the art disclosed herein, the form of addition of a colorant (favorably a black colorant such as carbon black particles) to the PSA composition is not particularly limited. The colorant such as carbon black particles can be added to the PSA composition in the form of a dispersion in which the particles are dispersed in a dispersion medium. The dispersion medium forming the dispersion is not particularly limited. Examples include water (ion-exchanged water, reverse osmosis water, distilled water, etc.), various organic solvents (alcohols such as ethanol; ketones such as acetone; ethers such as butyl cellosolve, propylene glycol monomethyl ether acetate; esters such as ethyl acetate; aromatic hydrocarbons such as toluene; mixed solvents of these), and aqueous mixed solvents of water and these organic solvents. The dispersion may also comprise an aforementioned dispersant. By mixing the dispersion with a PSA composition, the PSA composition may also further comprise the dispersant while comprising the colorant (favorably a black colorant such as carbon black particles).

The amount of the colorant (favorably a black colorant such as carbon black particles) included is not particularly limited. It can be suitably selected in view of the PSA layer thickness, light-blocking properties to be obtained, required adhesive properties, etc. The colorant content of the PSA layer is suitably about 0.1% by weight or higher. From the standpoint of the light-blocking properties, it is preferably about 0.5% by weight or higher, more preferably about 1% by weight or higher, yet more preferably about 2% by weight or higher, particularly preferably about 2.5% by weight or higher, or possibly even, for instance, about 3% by weight or higher. The amount of the colorant (favorably a black colorant such as carbon black particles) included is possibly about 50% by weight or lower, or suitably about 30% by weight or lower. From the standpoint of the adhesive properties, etc., it is preferably about 10% by weight or lower. When the refractive index enhancement takes priority or when the adhesive properties such as bonding strength are of more importance, the amount of the colorant (favorably a black colorant such as carbon black particles) included is preferably about 7% by weight or lower, more preferably about 5% by weight or lower, or possibly even about 3% by weight or lower.

When the art disclosed herein is implemented in an embodiment having a PSA layer comprising the aforementioned particles P_{HRI} and colorant (e.g., a black colorant, favorably carbon black particles), the content ratio between the particles P_{HRI} and the colorant can be selected to obtain the target refractive index and light-blocking properties, and thus it is not limited to a specific range. The content ratio between the particles P_{HRI} and the colorant is desirably in a range undamaging to their dispersity, compatibility, etc., in the PSA layer. For instance, the weight ratio (C_{HRI}/C_{CB}) of the particle P_{HRI} content C_{HRI} to the carbon black particle (colorant) content C_{CB} can be in the range between 1 and 100. From the standpoint of enhancing the effect of particles P_{HRI}, the ratio C_{HRI}/C_{CB} value is suitably 5 or higher and can be preferably 10 or higher, more preferably 20 or higher, yet more preferably 25 or higher, or even 30 or higher. In an embodiment comprising particles P_{HRI}, from the standpoint of favorable coloring (blackening) with the carbon black particle content, the ratio C_{HRI}/C_{CB} value is suitably 70 or lower, preferably 50 or lower, or more preferably 40 or lower, for instance, possibly even 35 or lower.

The PSA composition disclosed herein may comprise a component that contributes to enhancement of the colorant dispersity. The dispersity enhancer can be, for instance, a polymer, oligomer, liquid resin or surfactant (anionic, cationic, nonionic or amphoteric surfactant). As the dispersity enhancer, solely one species or a combination of two or more species can be used. The dispersity enhancer is preferably dissolved in the PSA composition. The oligomer can be a low molecular weight polymer formed of monomers including one, two or more species of acrylic monomer as the examples shown earlier (e.g., an acrylic oligomer having a Mw below about 10 × 10⁴, or preferably below 5 × 10⁴). The liquid resin can be, for instance, a tackifier resin (typically, a rosin-based, terpene-based, or hydrocarbon-based tackifier resin, or the like, e.g., hydrogenated rosin methyl ester, etc.). Such a dispersity enhancer can inhibit uneven dispersion of the colorant (e.g., particulate black colorant such as carbon black) and further inhibit uneven coloring of the PSA layer. Therefore, a PSA sheet can be formed with a good appearance.

The way of adding the dispersity enhancer is not particularly limited. It may be included in a solution containing a colorant (favorably a black colorant such as carbon black particles) before added to the PSA composition; or it may be supplied to the PSA composition simultaneously with a colorant, or before or after colorant addition.

The amount of dispersity enhancer is not particularly limited. From the standpoint of reducing its influence on the adhesive properties (e.g., lowering of the cohesion), relative to the entire PSA layer, it is suitably about 20% by weight or less (preferably about 10% by weight or less, more preferably 7% by weight or less, e.g., about 5% by weight or less). In some embodiments, the amount of dispersity enhancer can be up to about 10-fold (preferably up to about 5-fold, e.g., up to about 3-fold) of the colorant’s weight. On the other hand, from the standpoint of favorably obtaining the effect of dispersity enhancer, its amount is suitably about 0.2% by weight or more (typically about 0.5% by weight or more, preferably about 1% by weight or more) of the entire PSA layer. In some embodiments, the amount of dispersity enhancer can be at least about 0.2-fold (preferably at least about 0.5-fold, e.g., at least 1-fold) of the colorant’s weight.

### Tackifier Resin

The PSA layer in the art disclosed herein may include a tackifier resin. This can increase the peel strength of the PSA sheet. As the tackifier resin, one, two or more species can be used, selected among various known tackifier resins such as a phenolic tackifier resin, a terpene tackifier resin, a modified terpene tackifier resin, a rosin tackifier resin, a hydrocarbon tackifier resin, an epoxy tackifier resin, a polyamide tackifier resin, an elastomer tackifier resin, and a ketone tackifier resin.

Examples of the phenolic tackifier resins include terpene phenolic resins, hydrogenated terpene phenolic resins, alkylphenolic resins, and rosin phenolic resins.

The term “terpene phenolic resin” refers to a resin including a terpene residue and a phenol residue, and is inclusive of both a copolymer of a terpene and a phenol compound (terpene-phenol copolymer resin) and a phenol-modified homopolymer or copolymer of a terpene (phenol-modified terpene resin). Preferable examples of terpenes constituting such terpene phenolic resins include monoterpenes such as α-pinene, β-pinene, and limonene (including d-form, l-form and d/l form (dipentene)). The hydrogenated terpene phenolic resin has a structure obtained by hydrogenating such a terpene phenolic resin. Such a resin is sometimes referred to as a hydrogen-added terpene phenolic resin.

The alkylphenolic resin is a resin (oily phenolic resin) obtainable from an alkylphenol and formaldehyde. Examples of alkylphenol resins include novolac type and resole type resins.

A rosin phenolic resin is typically a phenol-modified product of rosins or various rosin derivatives (including rosin esters, unsaturated fatty acid-modified rosins, and unsaturated fatty acid-modified rosin esters) described later. Examples of the rosin phenolic resin include rosin phenolic resins obtained, for example, by a method of adding a phenol to a rosin or the rosin derivative with an acid catalyst and thermally polymerizing.

Examples of terpene-based tackifier resins include polymers of terpenes (typically monoterpenes) such as α-pinene, β-pinene, d-limonene, 1-limonene, and dipentene. The polymer may be a homopolymer of one type of terpene or a copolymer of two or more types of terpenes. The homopolymers of one type of terpene can be exemplified by an α-pinene polymer, P-pinene polymer, and a dipentene polymer. The modified terpene resin is exemplified by modifications of the terpene resin. Specific examples include styrene-modified terpene resins and hydrogenated terpene resins.

The term “rosin-based tackifier resin” as used herein is inclusive of both rosins and rosin derivative resins. Examples of rosins include unmodified rosins (raw rosins) such as gum rosin, wood rosin, and tall oil rosin, and modified rosins obtained by modification of the unmodified rosins by hydrogenation, disproportionation, polymerization, and the like (hydrogenated rosins, disproportionated rosins, polymerized rosins, and other chemically modified rosins).

The rosin derivative resin is typically a derivative of an aforementioned rosin. The term “rosin-based resin” as used herein is inclusive of derivatives of unmodified rosins and derivatives of modified rosins (including hydrogenated rosins, disproportionated rosins and polymerized rosins). Examples thereof include rosin esters such as unmodified rosin esters which are esters of unmodified rosins and alcohols, and modified rosin esters which are esters of modified rosins and alcohols; unsaturated fatty acid-modified rosins obtained by modification of rosins with unsaturated fatty acids; unsaturated fatty acid-modified rosin esters obtained by modification of rosin esters with unsaturated fatty acids; rosin alcohols obtained by reduction treatment of carboxy groups of rosins or various abovementioned rosin derivatives (including rosin esters, unsaturated fatty acid-modified rosins and unsaturated fatty acid-modified rosin esters); and metal salts of rosins or various abovementioned rosin derivatives. Specific examples of rosin esters include methyl esters, triethylene glycol esters, glycerin esters, and pentaerythritol esters of unmodified rosins or modified rosins (hydrogenated rosins, disproportionated rosins, polymerized rosins, and the like).

Examples of the hydrocarbon-based tackifier resin include various hydrocarbon resins such as aliphatic hydrocarbon resins, aromatic hydrocarbon resins, aliphatic cyclic hydrocarbon resins, aliphatic/aromatic petroleum resins (styrene-olefin copolymers and the like), aliphatic/alicyclic petroleum resins, hydrogenated hydrocarbon resin, coumarone resins, and coumarone indene resins.

The softening point of the tackifier resin is not particularly limited. From the standpoint of improving the cohesiveness, in some embodiments, a tackifier resin having a softening point (softening temperature) of about 80° C. or higher (preferably, about 100° C. or higher) can be preferably used. The art disclosed herein can be preferably implemented in an embodiment in which more than 50% by weight (more preferably, more than 70% by weight, for example, more than 90% by weight) of the total amount of the tackifier resin (taken as 100% by weight) contained in the PSA layer is taken by a tackifier resin having the abovementioned softening point. For example, a phenolic tackifier resin (terpene phenolic resin or the like) having such a softening point can be advantageously used. The tackifier resin may include, for example, a terpene phenolic resin having a softening point of about 135° C. or higher (furthermore, about 140° C. or higher). The upper limit of the softening point of the tackifier resin is not particularly limited. From the standpoint of improving the adhesion to an adherend, in some embodiments, a tackifier resin having a softening point of about 200° C. or lower (more preferably about 180° C. or lower) can be preferably used. The softening point of the tackifier resin can be measured based on a softening point test method (ring and ball method) prescribed in JIS K 2207.

In some preferable embodiments, the tackifier resin includes one or two or more phenolic tackifier resins (typically, a terpene phenolic resin). The art disclosed herein can be preferably implemented, for instance, in an embodiment where a terpene phenolic resin corresponds to about 25% by weight or more (more preferably, about 30% by weight or more) with the total amount of the tackifier resin being 100% by weight. About 50% by weight or more of the total amount of the tackifier resin may be a terpene phenolic resin, and about 80% by weight or more (e.g., about 90% by weight or more) may be a terpene phenolic resin. Substantially all of the tackifier resin (e.g., about 95% by weight to 100% by weight, even about 99% by weight to 100% by weight) may be a terpene phenolic resin.

While no particular limitations are imposed, in some embodiments, the tackifier resin may include a tackifier resin having a hydroxyl value higher than 20 mg KOH/g. Among such tackifier resins, a tackifier resin having a hydroxyl value of 30 mg KOH/g or more is preferable. Hereinafter, a tackifier resin having a hydroxyl value of 30 mg KOH/g or more may be referred to as a “high-hydroxyl-value resin”. With the tackifier resin including such a high-hydroxyl-value resin, a PSA layer can be obtained that shows excellent adhesion to the adherend and high cohesive strength. In some embodiments, the tackifier resin may include a high-hydroxyl-value resin having a hydroxyl value of 50 mg KOH/g or higher (more preferably, 70 mg KOH/g or higher).

As the hydroxyl value, it is possible to use a value determined by the potentiometric titration method specified in JIS K0070:1992.

As the high-hydroxyl-value resin, a species having at least a prescribed hydroxyl value can be used among the various tackifier resins described earlier. The high-hydroxyl-value resins can be used singly as one species or in a combination of two or more species. For example, a phenolic tackifier resin having a hydroxyl value of 30 mgKOH/g or higher can be preferably used as the high-hydroxyl-value resin. In some preferable embodiments, a terpene phenolic resin having a hydroxyl value of 30 mgKOH/g or higher is used as the tackifier resin. The terpene phenolic resin is advantageous because the hydroxyl value can be controlled at will through the copolymerization ratio of phenol.

The maximum hydroxyl value of the high-hydroxyl-value resin is not particularly limited. From the standpoint of the compatibility with the base polymer and the like, the hydroxyl value of the high-hydroxyl-value resin is suitably about 200 mgKOH/g or lower, preferably about 180 mgKOH/g or lower, more preferably about 160 mgKOH/g or lower, and even more preferably about 140 mgKOH/g or lower. The art disclosed herein can be preferably implemented in an embodiment in which the tackifier resin includes a high-hydroxyl-value resin (e.g., a phenol-based tackifier resin, preferably a terpene phenolic resin) having a hydroxyl value of 30 mgKOH/g to 160 mgKOH/g. In some embodiments, a high-hydroxyl-value resin having a hydroxyl value of 30 mgKOH/g to 80 mgKOH/g (e.g., 30 mgKOH/g to 65 mgKOH/g) can be preferably used. In other embodiments, a high-hydroxyl-value resin having a hydroxyl value of 70 mgKOH/g to 140 mgKOH/g can be preferably used.

While no particular limitations are imposed, when a high-hydroxyl-value resin is used, the ratio of high-hydroxyl-value resin (e.g., a terpene phenolic resin) to the entire tackifier resin in the PSA layer can be, for example, about 25% by weight or higher, preferably about 30% by weight or higher, and more preferably about 50% by weight or higher (e.g., about 80% by weight or higher, typically about 90% by weight or higher). Substantially all of the tackifier resin (e.g., about 95% by weight to 100% by weight, more preferably about 99% by weight to 100% by weight) may be a high-hydroxyl-value resin.

When the PSA layer includes a tackifier resin, the amount of the tackifier resin used is not particularly limited, and may be suitably selected in a range of, for example, about 1 part to 100 parts by weight to 100 parts by weight of the base polymer. From the standpoint of favorably obtaining the effect to increase the peel strength, the amount of the tackifier resin used to 100 parts by weight of the base polymer (e.g., acrylic polymer) is suitably 5 parts by weight or greater, preferably 10 parts by weight or greater, or possibly 15 parts by weight or greater. From the standpoint of the impact resistance and cohesive strength, the amount of the tackifier resin used to 100 parts by weight of the base polymer (e.g., acrylic polymer) is suitably 50 parts by weight or less, possibly 40 parts by weight or less, or even 30 parts by weight or less.

### Crosslinking Agent

In the art disclosed herein, the PSA composition used for forming the PSA layer may comprise a crosslinking agent as necessary. The type of crosslinking agent is not particularly limited and a suitable species can be selected and used among heretofore known crosslinking agents. Examples of the crosslinking agent include isocyanate-based crosslinking agents, epoxy-based crosslinking agents, oxazoline-based crosslinking agents, aziridine-based crosslinking agents, melamine-based crosslinking agents, peroxide-based crosslinking agents, urea-based crosslinking agents, metal alkoxide-based crosslinking agents, metal chelate-based crosslinking agents, metal salt-based crosslinking agents, carbodiimide-based crosslinking agents, hydrazine-based crosslinking agents, amine-based crosslinking agents, and silane coupling agents. Among them, isocyanate-based crosslinking agents, epoxy-based crosslinking agents, oxazoline-based crosslinking agents, aziridine-based crosslinking agents and melamine-based crosslinking agents are preferable; isocyanate-based crosslinking agents and epoxy-based crosslinking agents are more preferable; and isocyanate-based crosslinking agents are particularly preferable. The use of an isocyanate-based crosslinking agent tends to bring about impact resistance superior to other crosslinked matrices while obtaining the PSA layer’s cohesive strength. For instance, it is also advantageous to use an isocyanate-based crosslinking agent in improving the adhesive strength to an adherend formed of polyester resin such as PET. For the crosslinking agent, solely one species or a combination of two or more species can be used.

As the isocyanate-based crosslinking agent, it is preferable to use a polyfunctional isocyanate (which refers to a compound having an average of two or more isocyanate groups per molecule, including a compound having an isocyanurate structure). For the isocyanate-based crosslinking agent, solely one species or a combination of two or more species can be used.

Examples of the polyfunctional isocyanate include aliphatic polyisocyanates, alicyclic polyisocyanates, and aromatic polyisocyanates.

Examples of an aliphatic polyisocyanate include 1,2-ethylene diisocyanate; tetramethylene diisocyanates such as 1,2-tetramethylene diisocyanate, 1,3-tetramethylene diisocyanate, 1,4-tetramethylene diisocyanate, etc.; hexamethylene diisocyanates such as 1,2-hexamethylene diisocyanate, 1,3-hexamethylene diisocyanate, 1,4-hexamethylene diisocyanate, 1,5-hexamethylene diisocyanate, 1,6-hexamethylene diisocyanate, 2,5-hexamethylene diisocyanate, etc.; 2-methyl-1,5-pentane diisocyanate, 3-methyl-1,5-pentane diisocyanate, and lysine diisocyanate.

Examples of an alicyclic polyisocyanate include isophorone diisocyanate; cyclohexyl diisocyanates such as 1,2-cyclohexyl diisocyanate, 1,3-cyclohexyl diisocyanate, 1,4-cyclohexyl diisocyanate, etc.; cyclopentyl diisocyanates such as 1,2-cyclopentyl diisocyanate, 1,3-cyclopentyl diisocyanate etc.; hydrogenated xylylene diisocyanate, hydrogenated tolylene diisocyanate, hydrogenated diphenylmethane diisocyanate, hydrogenated tetramethylxylene diisocyanate, and 4,4′-dicyclohexylmethane diisocyanate.

Examples of an aromatic polyisocyanate include 2,4-tolylene diisocyanate, 2,6-tolylene diisocyanate, 4,4′-diphenylmethane diisocyanate, 2,4′-diphenylmethane diisocyanate, 2,2′-diphenylmethane diisocyanate, 4,4′-diphenylether diisocyanate, 2-nitrodiphenyl-4,4′-diisocyanate, 2,2′-diphenylpropane-4,4′-diisocyanate, 3,3′-dimethyldiphenylmethane-4,4′-diisocyanate, 4,4′-diphenylpropane diisocyanate, m-phenylene diisocyanate, p-phenylene diisocyanate, naphthylene-1,4-diisocyanate, naphthylene-1,5-diisocyanate, 3,3′-dimethoxydiphenyl-4,4′-diisocyanate, xylylene-1,4-diisocyanate, and xylylene-1,3-diisocyanate.

A preferable example of the polyfunctional isocyanate has an average of three or more isocyanate groups per molecule. Such a tri-functional or higher polyfunctional isocyanate can be a multimer (typically a dimer or a trimer), a derivative (e.g., an adduct of a polyol and two or more polyfunctional isocyanate molecules), a polymer or the like of a di-functional, tri-functional, or higher polyfunctional isocyanate. Examples include polyfunctional isocyanates such as a dimer and a trimer of a diphenylmethane diisocyanate, an isocyanurate (a cyclic trimer) of a hexamethylene diisocyanate, a reaction product of trimethylol propane and a tolylene diisocyanate, a reaction product of trimethylol propane and a hexamethylene diisocyanate, polymethylene polyphenyl isocyanate, polyether polyisocyanate, and polyester polyisocyanate. Commercially available polyfunctional isocyanates include product name DURANATE TPA-100 available from Asahi Kasei Chemicals Corporation and product names CORONATE L, CORONATE HL, CORONATE HK, CORONATE HX, and CORONATE 2096 available from Tosoh Corporation.

The amount of isocyanate-based crosslinking agent used is not particularly limited. For example, it can be about 0.5 part by weight or greater to 100 parts by weight of the base polymer. From the standpoint of combining cohesive strength with tightness of adhesion and of the impact resistance and so on, the amount of isocyanate-based crosslinking agent used to 100 parts by weight of the base polymer may be, for example, 1.0 part by weight or greater, or preferably 1.5 parts by weight or greater (typically 2.0 parts by weight or greater, e.g., 2.5 parts by weight or greater). From the standpoint of obtaining tighter adhesion to the adherend, the amount of the isocyanate-based crosslinking agent used is suitably 10 parts by weight or less, 8 parts by weight or less, or even 5 parts by weight or less (e.g., 3 parts by weight or less) to 100 parts by weight of the base polymer.

In some preferable embodiments, as the crosslinking agent, an isocyanate-based crosslinking agent is used in combination with at least one other species of crosslinking agent having a crosslinkable functional group different from that of the isocyanate-based crosslinking agent (or a “non-isocyanate-based crosslinking agent). According to the art disclosed herein, the combined use of isocyanate-based crosslinking agent and non-isocyanate-based crosslinking agent can bring about excellent cohesive strength. For instance, it can favorably combine high heat-resistant cohesive strength and excellent metal corrosion inhibition in an embodiment comprising a rust inhibitor such as azole-based rust inhibitor. The PSA layer in the art disclosed herein may include the crosslinking agent, for instance, in a crosslinked form, in a pre-crosslinked form, in a partially crosslinked form, in an intermediate or combined form of these. In typical, the crosslinking agent is included in the adhesive layer mostly in a crosslinked form.

There are no particular limitations to the type of non-isocyanate-based crosslinking agent that can be used in combination with the isocyanate-based crosslinking agent. A suitable species can be selected and used among the crosslinking agents described above. The non-isocyanate-based crosslinking agents can be used singly as one species or in a combination of two or more species.

In some preferable embodiments, an epoxy-based crosslinking agent can be used as the non-isocyanate-based crosslinking agent. For instance, with the combined use of isocyanate-based and epoxy-based crosslinking agents, cohesion is likely to be combined with impact resistance. As the epoxy-based crosslinking agent, a compound having two or more epoxy groups in a molecule can be used without particular limitation. An epoxy-based crosslinking agent having 3 to 5 epoxy groups in a molecule is preferable. Epoxy-based crosslinking agents can be used singly as one species or in a combination of two or more species.

Specific examples of the epoxy-based crosslinking agent include, but are not limited to, N,N,N′,N′-tetraglycidyl-m-xylenediamine, 1,3-bis(N,N-diglycidylaminomethyl)cyclohexane, 1,6-hexanediol diglycidyl ether, polyethylene glycol diglycidyl ether, and polyglycerol polyglycidyl ether. Examples of commercially available epoxy-based crosslinking agents include product names TETRAD-C and TETRAD-X both available from Mitsubishi Gas Chemical Co., Inc., product name EPICLON CR-5L available from DIC Corp., product name DENACOL EX-512 available from Nagase ChemteX Corporation, and product name TEPIC-G available from Nissan Chemical Industries, Ltd.

The amount of the epoxy-based crosslinking agent to be used is not particularly limited. The amount of the epoxy-based crosslinking agent to be used can be, for example, more than 0 part by weight and about 1 part by weight or less (typically about 0.001 part to 0.5 part by weight) to 100 parts by weight of the base polymer. From the standpoint of favorably obtaining the effect to increase the cohesive strength, the amount of epoxy-based crosslinking agent used is suitably about 0.002 part by weight or greater, preferably about 0.005 part by weight or greater, or more preferably about 0.008 part by weight or greater to 100 parts by weight of the base polymer. From the standpoint of obtaining tighter adhesion to an adherend, the amount of the epoxy-based crosslinking agent used is suitably about 0.2 part by weight or less, preferably about 0.1 part by weight or less, more preferably less than about 0.05 part by weight, or even more preferably less than about 0.03 part by weight (e.g., about 0.025 part by weight or less) to 100 parts by weight of the base polymer. With decreasing amount of epoxy-based crosslinking agent used, the impact resistance tends to improve.

In the art disclosed herein, the relative amounts of isocyanate-based crosslinking agent and non-isocyanate-based crosslinking agent (e.g., epoxy-based crosslinking agent) are not particularly limited. For instance, the amount of non-isocyanate-based crosslinking agent can be about 1/50 or less of the amount of isocyanate-based crosslinking agent. From the standpoint of more favorably bringing about tight adhesion to the adherend and cohesive strength, the amount of non-isocyanate-based crosslinking agent is suitably about 1/75 or less, or preferably about 1/100 or less (e.g., 1/150 or less) of the amount of isocyanate-based crosslinking agent by weight. From the standpoint of favorably obtaining the effect of the combined use of isocyanate-based crosslinking agent and non-isocyanate-based crosslinking agent (e.g., epoxy-based crosslinking agent), the amount of the non-isocyanate-based crosslinking agent is suitably about 1/1000 or more, for example, about 1/500 or more of the amount of isocyanate-based crosslinking agent.

The total use (total amount) of crosslinking agent is not particularly limited. For instance, it can be about 10 parts by weight or less to 100 parts by weight of the base polymer (favorably an acrylic polymer) or selected from a range of preferably about 0.005 part to 10 parts by weight, or more preferably about 0.01 part to 5 parts by weight.

### Rust Inhibitor

The PSA layer according to some preferable embodiments may include a rust inhibitor. As the rust inhibitor, an azole-based rust inhibitor can be preferably used. The rust-inhibitor-containing PSA layer is preferable in a case that requires metal corrosion inhibition such as when applied to a metal. A preferable azole-based rust inhibitor comprises an azole-based compound (a five-membered cyclic aromatic compound having two or more hetero atoms with at least one of which being a nitrogen atom) as an active ingredient. As the azole-based compound, a suitable species can be selected among those used heretofore as rust inhibitors for metals such as copper.

Examples of the azole-based compound include azoles such as imidazole, pyrazole, oxazole, isoxazole, thiazole, isothiazole, selenazole, 1,2,3-triazole, 1,2,4-triazole, 1,2,5-oxadiazole, 1,3,4-oxadiazole, 1,2,3-thiadiazole, 1,2,4-thiadiazole, 1,3,4-thiadiazole, tetrazole, and 1,2,3,4-thiatriazole; derivatives thereof; amine salts thereof; and metal salts thereof. Examples of azole derivatives include compounds having a structure including a condensed ring of an azole ring and another ring such as a benzene ring. Specific examples thereof include indazole, benzimidazole, benzotriazole (that is, 1,2,3-benzotriazole having a structure in which an azole ring of 1,2,3-triazole is condensed with a benzene ring), and benzothiazole, and derivatives thereof such as alkylbenzotriazoles (e.g., 5-methylbenzotriazole, 5-ethylbenzotriazole, 5-n-propylbenzotriazole, 5-isobutylbenzotriazole, and 4-methylbenzotriazole), alkoxybenzotriazoles (e.g., 5-methoxybenzotriazole), alkylaminobenzotriazoles, alkylaminosulfonylbenzotriazoles, mercaptobenzotriazole, hydroxybenzotriazole, nitrobenzotriazoles (e.g., 4-nitrobenzotriazole), halobenzotriazoles (e.g., 5-chlorobenzotriazole), hydroxyalkylbenzotriazoles, hydroxybenzotriazoles, aminobenzotriazoles, (substituted aminomethyl)-tolyltriazoles, carboxybenzotriazole, N-alkylbenzotriazoles, bisbenzotriazoles, naphthotriazoles, mercaptobenzothiazole, and aminobenzothiazole, amine salts thereof, and metal salts thereof. Other examples of azole derivatives include an azole derivative having a non-condensed ring structure, for example, compounds with a structure having a substituent on a non-condensed azole ring, for example, 3-amino-1,2,4-triazole and 5-phenyl-1H-tetrazole. The azole compounds can be used singly as one species or in a combination of two or more species.

Preferable examples of compounds that can be used as the azole-based rust inhibitor include benzotriazole-based rust inhibitors including a benzotriazole compound as an active ingredient. The art disclosed herein can be preferably implemented, for example, in an embodiment in which the base polymer is an acrylic polymer and the rust inhibitor is a benzotriazole-based rust inhibitor. In such an embodiment, a PSA sheet can be favorably obtained that provides satisfactory metal corrosion inhibition and excellent bonding reliability. Favorable examples of the benzotriazole-based compound include 1,2,3-benzotriazole, 5-methylbenzotriazole, 4-methylbenzotriazole, and carboxybenzotriazole.

Examples of the non-azole-based rust inhibitor possibly in the PSA layer disclosed herein are not particularly limited. Examples include amine compounds, nitrites, ammonium benzoate, ammonium phthalate, ammonium stearate, ammonium palmitate, ammonium oleate, ammonium carbonate, salts of dicyclohexylaminebenzoic acid, urea, urotropin, thiourea, phenyl carbamate, and cyclohexylammonium-N-cyclohexyl carbamate (CHC). These rust inhibitors which are not azole compounds (non-azole-based rust inhibitors) can be used singly as one species or in a combination of two or more species. Alternatively, the art disclosed herein can also preferably be implemented in an embodiment that uses essentially no non-azole-based rust inhibitor.

The amount of the azole-based rust inhibitor (favorably an azole-based rust inhibitor, e.g., a benzotriazole-based rust inhibitor) is not particularly limited, and can be, for example, 0.01 part by weight or greater (typically 0.05 parts by weight or greater) to 100 parts by weight of the base polymer. From the standpoint of obtaining greater inhibition of metal corrosion, the amount may be 0.1 part by weight or greater, 0.3 part by weight or greater, or 0.5 part by weight or greater. From the standpoint of increasing the cohesive strength of the PSA, the amount of rust inhibitor is suitably less than 8 parts by weight, possibly 6 parts by weight or less, or even 5 parts by weight or less to 100 parts by weight of the base polymer.

### Other Additives

The PSA composition may include, as necessary, various additives which are common in the field of PSA compositions, such as a leveling agent, crosslinking aid, plasticizer, softener, antistatic agent, aging-preventing agent, UV absorber, antioxidant, and light stabilizer. As for these various additives, heretofore known species can be used by conventional methods, and the present invention is not particularly characterized thereby. Therefore, detailed description is omitted.

### PSA Composition

The PSA layer disclosed herein can be formed from an aqueous PSA composition, solvent-based PSA composition, hot-melt PSA composition, or active energy ray-curable PSA composition which cures upon irradiation of active energy rays such as UV rays and electron beam. The aqueous PSA composition refers to a PSA composition that comprises a PSA (PSA layer-forming components) in a solvent whose primary component is water (an aqueous solvent), typically including a so-called water-dispersed PSA composition (in which the PSA is at least partially dispersed in water). Further, the solvent-based PSA composition refers to a PSA composition that comprises a PSA in an organic solvent. As the organic solvent in the solvent-based PSA composition, among the examples (toluene, ethyl acetate, etc.) of the organic solvent possibly used in the solution polymerization, one, two or more species can be used without particular limitations. From the standpoint of adhesive properties and the like, the art disclosed herein can be preferably implemented in an embodiment in which the PSA layer is formed from a solvent-based PSA composition. In an embodiment having a solvent-based PSA layer formed from a solvent-based PSA composition, the effect of the art disclosed herein to increase the refractive index can be preferably obtained.

Based on the above, this Description provides a PSA composition comprising one, two or more species of components possibly included in the PSA layer disclosed herein. The use of this PSA composition brings about a PSA sheet having an increased refractive index and good impact resistance. The PSA composition comprises a base polymer and may favorably include particles P_{HRI}. It may also include a colorant (preferably a black colorant, more preferably carbon black particles. In addition, it may include components possibly included in the PSA layer described above. In the PSA composition, the amount (% by weight) of each component possibly in the PSA layer corresponds to the amount (% by weight) based on the solid content (or by non-volatiles). With respect to other specifics of the PSA composition are as described about the PSA layer and thus redundant details are omitted.

### Formation of PSA Layer

The PSA layer disclosed herein can be formed by a conventionally known method. For instance, it is possible to use a method where a PSA composition is applied to a releasable surface (release face) and allowed to dry to form a PSA layer. As the release face, for instance, the surface of the release liner described later can be preferably used.

The PSA composition can be applied with a heretofore known coater, for instance, a gravure roll coater, die coater, and bar coater. Alternatively, the PSA composition can be applied by immersion, curtain coating, etc.

From the standpoints of accelerating the crosslinking reaction, improving production efficiency, and the like, it is preferable to dry the PSA composition under heating. The drying temperature can be, for example, about 40° C. to 150° C., and preferably about 60° C. to 130° C. After dried, the PSA composition can be subjected to aging to adjust the distribution or migration of components within the PSA layer, to allow the crosslinking reaction to proceed, to reduce possible distortion in the PSA layer, and so on.

The PSA layer disclosed herein may have a monolayer structure or a multilayer structure with two or more layers. From the standpoint of the productivity, etc., the PSA layer preferably has a monolayer structure. Alternatively, in the PSA layer, components such as the aforementioned particles P_{HRI} may be locally present in a certain thickness range on the PSA layer surface side, or components such as colorants may be locally present in a certain area of the PSA layer. Such an embodiment can also bring about a PSA sheet having a breaking strength up to a prescribed value and a refractive index of a prescribed value or higher. The PSA layer having a multilayer structure or the PSA layer with localized presence of specific components can be obtained by laminating PSA layers or PSA compositions having different compositions under suitable conditions (temperature, lamination speed, etc.) and so on.

The thickness of the PSA layer is not particularly limited. From the standpoint of preventing the PSA sheet from becoming excessively thick, the thickness of the PSA layer is suitably about 100 µm or less, preferably about 70 µm or less, and more preferably about 50 µm or less (e.g., about 30 µm or less). The PSA layer’s thickness can be about 35 µm or less, for instance, about 25 µm or less, even about 15 µm or less. The PSA layer with a limited thickness may well accommodate needs for thinning and weight saving. The minimum thickness of the PSA layer is not particularly limited. From the standpoint of the impact resistance and tightness of adhesion to an adherend, it is advantageously about 1 µm or greater, suitably about 3 µm or greater, preferably about 5 µm or greater, more preferably about 7 µm or greater, yet more preferably about 12 µm or greater (e.g., about 15 µm or greater), particularly preferably about 20 µm or greater, possibly about 30 µm or greater, about 35 µm or greater, or even about 40 µm or greater. Having at least a certain thickness, it is possible to preferably obtain desirable adhesive properties with limited light transmission (e.g., light-blocking properties). With the PSA layer having at least a prescribed thickness, superior impact resistance is likely to be obtained. It is noted that because the PSA sheet disclosed herein is a substrate-free PSA sheet, the thickness of the PSA layer is the total thickness of the PSA sheet (not including the release liner).

### Release Liner

In the art disclosed herein, a release liner can be used in formation of the PSA layer, preparation of the PSA sheet, storage, distribution and processing of the unused PSA sheet, etc. The release liner is not particularly limited, and examples thereof include a release liner having a release layer on the surface of a liner substrate such as a resin film or paper, and a release liner made of a low-adhesive material such as a fluoropolymer (polytetrafluoroethylene, etc.) or a polyolefin resin (polyethylene, polypropylene, etc.). The release layer can be formed, for example, by subjecting the liner substrate to surface treatment with a release agent such as a silicone-based, long-chain alkyl-based, fluorine-based agent kind, or molybdenum sulfide.

### Applications

The PSA sheet disclosed herein is suitable for applications to materials that are desired to have impact resistance and have higher refractive indices than general PSA. For instance, portable electronic devices are susceptible to being dropped because of their usage; and therefore, PSA sheets used in portable electronic devices may need to have impact resistance. With respect to such portable electronics, the PSA sheet disclosed herein is favorable. The PSA sheet disclosed herein has excellent impact resistance and thus can be preferably used to fix members in portable electronic devices having organic EL displays which are likely to require greater impact resistance.

Non-limiting examples of the portable electronic device include cell phones, smartphones, tablet PCs, notebook PCs, various wearable devices (e.g., wrist wears put on wrists such as wrist watches; modular devices attached to bodies with a clip, strap, etc.; eye wears including glass-shaped wears (monoscopic or stereoscopic, including head-mounted pieces); clothing types worn as, for instance, accessories on shirts, socks, hats/caps, etc.; ear wears such as earphones put on ears; etc.), digital cameras, digital video cameras, acoustic equipment (portable music players, IC recorders, etc.), calculators (e.g., pocket calculators), handheld game devices, electronic dictionaries, electronic notebooks, electronic books, vehicle navigation devices, portable radios, portable TVs, portable printers, portable scanners, and portable modems. As used herein, being “portable” means not just providing simple mobility, but further providing a level of portability that allows an individual (average adult) to carry it relatively easily.

Among these portable electronic devices, in a portable electronic device having a pressure sensor, the PSA sheet disclosed herein can be preferably used for fixing the pressure sensor and other components. In some preferable embodiments, the PSA sheet can be used for fixing a pressure sensor and other components in an electronic device (typically, a portable electronic device) equipped with a function to identify an absolute position on a panel corresponding to a screen (typically, a touch panel) with a device to specify the position on the screen (typically, a pen type or a mouse type device) and a device to detect the position.

The PSA sheet disclosed herein is suitable for an application in which it is placed on the back of a display (screen) such as a touch panel display in a portable electronic device to prevent light reflection on the display screen. Placement of the PSA sheet disclosed herein on the back of the display (screen) can prevent degradation of display visibility regardless of how the portable electronic device is used. The refection may be caused by a metallic component placed on the backside of the display screen. For instance, when the PSA sheet disclosed herein is used for the metallic component and the screen, light-blocking properties can be obtained along with attachment of the components.

The PSA sheet disclosed herein is suitable for a portable electronic device comprising an optical sensor. Various devices such as the aforementioned sort of portable electronic devices may have optical sensors using light such as IR light, visible light and UV light for purposes including device operation, nearby object detection, detection of the surrounding brightness (ambient light) and data communication. While no particular limitations are imposed, examples of the light sensor include an accelerometer, proximity sensor and brightness sensor (ambient light sensor). Such optical sensors have photodetector elements for light such as UV light, visible light and IR light and may also have emitters for specific light such as IR light. In other words, the optical sensor may include an emitter and/or a photodetector element for light in a specific wavelength range in the wavelength spectrum including UV light, visible light and IR light. The art disclosed herein can be applied to such a device to reduce reflection of the light used in the optical sensor, thereby preventing deterioration of sensor accuracy.

Examples of the material (adherend material) to which the PSA sheet disclosed herein is applied include, but are not limited to, metals such as copper, silver, gold, iron, tin, palladium, aluminum, nickel, titanium, chromium, zinc and an alloy of two or more species among these; various resin materials (typically, plastic materials) such as polyimide resin, acrylic resin, polyether nitrile resin, polyether sulfone resin, polyester resin (PET resin, polyethylene naphthalate resin, etc.), polyvinyl chloride resin, polyphenylene sulfide resin, polyether ether ketone resin, polyamide resin (so-called aramid resin, etc.), polyarylate resin, polycarbonate resin, and liquid crystal polymer; inorganic materials such as alumina, zirconia, soda glass, silica glass and carbon. Among them, metals such as copper, aluminum, and stainless steel, and resin materials (typically plastic materials) such as polyester resin (PET resin, etc.), polyimide resin, aramid resin and polyphenylene sulfide resin are widely used. The material may constitute a member of a product such as an electronic device. The PSA sheet disclosed herein can be applied to a member formed from the material. The material may constitute an article to be fixed (e.g., a backside member such as an electromagnetic wave shield and a reinforcing sheet) in the pressure sensor, screen, etc. The article to be fixed refers to the target object to which the PSA sheet is applied, that is, the adherend. For instance, in a portable electronic device, the backside member refers to a member placed on the opposite side to the front face (visible side) of the pressure sensor or screen. The article to be fixed may have a single layer structure or a multilayer structure, and its surface (face to be attached) to which the PSA sheet is applied may be subj ected to various types of surface treatment. The article to be fixed is not particularly limited. One example is a backside component having a thickness of about 1 µm or greater (typically, 5 µm or greater, for example, 60 µm or greater, and also 120 µm or greater) and about 1500 µm or less (e.g., 800 µm or less), but these values are not particularly limiting.

The member or material as an application target for the PSA sheet disclosed herein (at least one adherend for a double-faced PSA sheet) may be formed of a material having a higher refractive index than general PSAs. The adherend material has a refractive index of, for instance, 1.50 or higher. Certain adherend materials have refractive indices of 1.58 or higher and some of them even have refractive indices of 1.62 or higher (e.g., about 1.66). Adherend materials having such high refractive indices are typically resin materials. More specifically, it can be polyester-based resin such as PET, polyimide-based resin, aramid resin, polyphenylene sulfide-based resin, polycarbonate-based resin, etc. With such materials, the effect of using the PSA sheet disclosed herein (i.e., reduction of light reflection due to the difference in refractive index) can be preferably exhibited. The maximum refractive index of the adherend material is, for instance, 1.80 or lower, or possibly 1.70 or lower. The PSA sheet disclosed herein can be preferably used when applied to an adherend (e.g., a member) having a high refractive index as described above. Favorable examples of such adherends include a resin film having a refractive index of 1.50 to 1.80 (preferably 1.60 to 1.70). The refractive index can be determined by the same method as for the refractive index of the PSA sheet.

The difference in refractive index is suitably less than 0.18 between the member or material as the application target for the PSA sheet (i.e., at least one adherend for a double-faced PSA sheet) and the PSA sheet. This preferably reduces light reflection at the interface between the adherend and the PSA sheet. The difference in refractive index is preferably less than 0.12, more preferably less than 0.10, yet more preferably less than 0.08, or particularly preferably less than 0.05. Theoretically, the difference in refractive index is zero (±0.00); however, it can be practically allowed to have a difference of about 0.01 or greater (e.g., 0.03 or greater).

The member or material as an application target for the PSA sheet disclosed herein (at least one adherend for a double-faced PSA sheet) may have optically transparency. As for such an adherend, for instance, the sensor light passes through the adherend and reaches the PSA sheet. Thus, it is likely able to benefit from the effect of the art disclosed herein (i.e., reduction of light reflection at the interface between the adherend and the PSA sheet). The adherend has a total light transmittance of, for instance, higher than 50%, or possibly 70% or higher. In some preferable embodiments, the adherend’s total light transmittance is 80% or higher, more preferably 90% or higher, or possibly 95% or higher (e.g., 95% to 100%). Such materials can be resin films placed on backsides of image displays in various devices such as portable electronic devices. The PSA sheet disclosed herein can be preferably used when applied to such an adherend (e.g., a member) having a prescribed or higher total light transmittance. The total light transmittance can be determined by the same method as for the total light transmittance of the PSA sheet.

In some preferable embodiments, the adherend (e.g., a member) to which the PSA sheet is applied may have an aforementioned refractive index as well as an aforementioned total light transmittance. In particular, the PSA sheet can be preferably used when applied to an adherend (e.g., a member) having a refractive index of 1.50 or higher (e.g., 1.58 or higher, or even 1.62 or higher, typically about 1.66) while having a total light transmittance of higher than 50% (e.g., 70% or higher, preferably 80% or higher, more preferably 90% or higher, or possibly 95% or higher). When applied to such an adherend material, the effect of the art disclosed herein is particularly preferably obtained.

Based on the above, the art disclosed herein provides a laminate having a PSA sheet disclosed herein and a member to which the PSA sheet is adhered. The member to which the PSA sheet is adhered may have a refractive index comparable to that of the adherend material described above. The difference in refractive index between the PSA sheet and the member can be comparable to that between the adherend and the PSA sheet described above. The member constituting the laminate is as described above, regarded as the member, material and adherend. Thus, redundant details are not repeated.

For instance, the PSA sheet disclosed herein can be limited in light transmission and a preferable embodiment thereof can have excellent light-blocking properties; and therefore, it is preferably used in electronic devices that include various light sources such as LED (light-emitting diodes) and luminous components such as self-luminous organic EL (electro-luminescence). For instance, it can be preferably used in an electronic device (typically a portable electronic device) having a liquid crystal display that requires certain optical properties. More specifically, it can be preferably used in a liquid crystal display having a liquid crystal display module unit (LCD unit) and a backlight module unit (BL unit) to join the LCD and BL units.

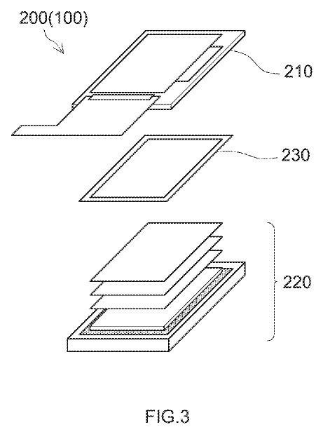

FIG. 3 shows an exploded perspective view schematically illustrating a constitutional example of the liquid crystal display. As shown in FIG. 3, a liquid crystal display 200 having a portable electronic device 100 comprises an LCD unit (component) 210 and a BL unit (component) 220. Liquid crystal display 200 further comprises a PSA sheet 230. In this constitutional example, PSA sheet 230 is in a form of an adhesively double-faced PSA sheet (double-faced PSA sheet) processed into a frame shape and is placed between BL unit 220 and LCD unit 210 joining the two. It is noted that BL unit 220 typically includes, besides a light source, a reflective sheet, a light-guiding panel, a diffusion sheet, a prism sheet, etc.

The PSA sheet disclosed herein can be processed into joints having various shapes and used, for instance, for joining the LCD and BL units as well as for other joining purposes. In a preferable embodiment, the joint has a narrow segment having a width less than 2.0 mm (e.g., less than 1.0 mm). The PSA sheet according to some preferable embodiments may show excellent light-blocking properties. Thus, it can produce good performance even when used as a joint having a shape (e.g., a frame shape) with such a narrow segment. In some embodiments, the narrow segment may have a width of 0.7 mm or less, 0.5 mm or less, or even about 0.3 mm or less. The minimum width of the narrow segment is not particularly limited. From the standpoint of the handling properties of the PSA sheet, it is suitably 0.1 mm or greater (typically 0.2 mm or greater).

The narrow segment is typically linear. Here, the concept of being linear encompasses shapes that are straight, curved, bent (e.g., L-shaped) and also ring-shaped (frame-shaped, circular, etc.) as well as their composite or intermediate shapes. The ring shape is not limited to a curved shape. The concept encompasses, for instance, a ring shape of which part or all is straight, such as a shape that conforms to the circumference of a square (i.e., a frame shape) and a shape that conforms to a sector shape. The narrow segment is not particularly limited in length. For instance, in an embodiment where the narrow segment has a length of 10 mm or greater (typically 20 mm or greater, e.g., 30 mm or greater), the effect of the art disclosed herein can be favorably obtained.

The matters disclosed by this description include the following:
(1) A liquid crystal display having a liquid crystal display module unit, a backlight module unit, and an adhesively double-faced PSA sheet joining the liquid crystal display module unit and the backlight module unit, wherein
   the PSA sheet is an adhesively double-faced PSA sheet that consists of a PSA layer and is free of a substrate, and
   the PSA sheet has a refractive index of 1.50 or higher and a breaking strength of 10 MPa or less.
(2) The liquid crystal display according to (1) above, comprising an optical sensor that comprises an emitter and/or a photodetector element for light in a specific wavelength range in the wavelength spectrum including UV light, visible light and IR light.
(3) The liquid crystal display according to (1) or (2) above, wherein the PSA sheet comprises at least one species of particles P_{HRI} selected among metal particles, metal compound particles, organic particles and organic/inorganic composite particles.
(4) The liquid crystal display according to (3) above, wherein the particle P_{HRI} content of the PSA sheet is 25% to 75% by weight.
(5) The liquid crystal display according to (3) or (4) above, wherein the particles P_{HRI} have a mean particle diameter in the range between 1 nm and 100 nm.
(6) The liquid crystal display according to any of (3) to (5) above, wherein the PSA sheet comprises carbon black particles in addition to the particles P_{HRI}.
(7) The liquid crystal display according to any of (1) to (6) above, wherein the PSA sheet has a thickness of 20 µm or greater and 50 µm or less.
(8) The liquid crystal display according to any of (1) to (7) above, wherein the PSA sheet comprises an acrylic polymer as base polymer.
(9) The liquid crystal display according to any of (1) to (8) above, wherein the PSA sheet is formed from a PSA composition comprising an isocyanate-based crosslinking agent and/or an epoxy-based crosslinking agent.
(10) The liquid crystal display according to any of (1) to (9) above, wherein the PSA sheet has a 180° peel strength of 2 N/10 mm or greater to a stainless steel plate.
(11) An adhesively double-faced PSA sheet consisting of a PSA layer and being free of a substrate, wherein
   the PSA sheet has a refractive index of 1.50 or higher and a breaking strength of 10 MPa or less.
(12) The PSA sheet according to (11) above, comprising at least one species of particles P_{HRI} selected among metal particles, metal compound particles, organic particles and organic/inorganic composite particles.
(13) The PSA sheet according to (12) above, wherein the particle P_{HRI} content is 25% to 75% by weight.
(14) The PSA sheet according to (12) or (13) above, wherein the particles P_{HRI} have a mean particle diameter in the range between 1 nm and 100 nm.
(15) The PSA sheet according to any of (12) to (14) above, comprising carbon black particles in addition to the particles P_{HRI}.
(16) The PSA sheet according to any of (11) to (15) above, having a thickness of 20 µm or greater and 50 µm or less.
(17) The PSA sheet according to any of (11) to (16) above, comprising an acrylic polymer as base polymer.
(18) The PSA sheet according to any of (11) to (17) above, that is formed from a PSA composition comprising an isocyanate-based crosslinking agent and/or an epoxy-based crosslinking agent.
(19) The PSA sheet according to any of (11) to (18) above, having a 180° peel strength of 2 N/10 mm or greater to a stainless steel plate.
(20) The PSA sheet according to any of (11) to (19) above, wherein the PSA layer comprises a black colorant.
(21) The PSA sheet according to any of (11) to (20) above, having a total light transmittance of 80% or lower and a refractive index of 1.50 or higher.
(22) The PSA sheet according to (21) above, wherein the total light transmittance is higher than 10% and 80% or lower.
(23) The PSA sheet according to (21) above, wherein the total light transmittance is 10% or lower.
(24) The PSA sheet according to any of (21) to (23) above, wherein the PSA layer comprises at least one species of particles P_{HRI} selected among metal particles, metal compound particles, organic particles and organic/inorganic composite particles.
(25) The PSA sheet according to (24) above, wherein the PSA layer comprises particles formed of a metal oxide as the particles P_{HRI}.
(26) The PSA sheet according to (24) or (25) above, wherein the particles P_{HRI} have a mean particle diameter in the range between 1 nm and 100 nm.
(27) The PSA sheet according to any of (24) to (26) above, wherein the particles P_{HRI} account for 25% by weight or more of the PSA layer.
(28) The PSA sheet according to any of (21) to (27) above, wherein the PSA layer is an acrylic PSA layer comprising an acrylic polymer as base polymer.
(29) The PSA sheet according to any of (21) to (28) above, wherein the PSA sheet has a thickness in the range between 10 µm and 50 µm.
(30) The PSA sheet according to any of (21) to (29) above, wherein the PSA layer comprises a black colorant.
(31) The PSA sheet according to any of (11) to (30) above, wherein
   the PSA layer comprises high-refractive-index particles P_{HRI}, and
   the particles P_{HRI} present in the PSA layer has a mean particle diameter of less than 100 nm and a standard deviation of 20 nm or less, wherein the mean particle diameter and the standard deviation are determined from a number-based particle distribution by TEM analysis.
(32) The PSA sheet according to any of (11) to (30) above, wherein
   the PSA layer comprises particles P_{HRI} formed of a metal oxide, and
   the particles P_{HRI} present in the PSA layer has a mean particle diameter of less than 100 nm and a standard deviation of 20 nm or less, wherein the mean particle diameter and the standard deviation are determined from a number-based particle distribution by TEM analysis.
(33) The PSA sheet according to (31) or (32) above, wherein the mean particle diameter of the particles P_{HRI} present in the PSA layer is less than 80 nm.
(34) The PSA sheet according to any of (31) to (33) above, wherein the particles P_{HRI} account for more than 20% by weight of the PSA layer.
(35) The PSA sheet according to any of (31) to (34) above, wherein the particles P_{HRI} consist of at least one species of particles selected among metal particles, metal compound particles, organic particles and organic/inorganic composite particles.
(36) The PSA sheet according to (35) above, wherein the particles P_{HRI} are formed of a metal oxide.
(37) The PSA sheet according to any of (31) to (36) above, wherein the PSA layer is a solvent-based PSA layer formed from a solvent-based PSA composition.
(38) The PSA sheet according to any of (31) to (37) above, wherein the PSA layer is an acrylic PSA layer comprising an acrylic polymer as base polymer.
(39) The PSA sheet according to any of (31) to (38) above, wherein the particles P_{HRI} are hydrophobized (have been subjected to a hydrophobic surface treatment).
(40) The PSA sheet according to any of (31) to (39) above, wherein the PSA sheet has a thickness in the range between 10 µm and 50 µm.
(41) The PSA sheet according to any of (11) to (40) above, wherein the PSA layer comprises carbon black particles.
(42) The PSA sheet according to (41) above, wherein the carbon black particles have a volume average particle diameter of 500 nm or less.
(43) The PSA sheet according to (41) or (42) above, wherein the carbon black particle content of the PSA layer is 1% by weight or higher.
(44) The PSA sheet according to any of (41) to (43) above, wherein the PSA layer comprises, in addition to the carbon black particles,
   at least one species of particles P_{HRI} selected among metal particles, metal compound particles, organic particles and organic/inorganic composite particles.
(45) The PSA sheet according to (44) above, wherein the PSA layer comprises particles formed of a metal oxide as the particles P_{HRI}.
(46) The PSA sheet according to (44) or (45) above, wherein the particles P_{HRI} have a mean particle diameter in the range between 1 nm and 100 nm.
(47) The PSA sheet according to any of (44) to (46) above, having a weight ratio (C_{HRI}/C_{CB}) of the particle P_{HRI} content C_{HRI} to the carbon black particle content C_{CB} in the range between 1 and 100.
(48) The PSA sheet according to any of (41) to (47) above, wherein the PSA layer is an acrylic PSA layer comprising an acrylic polymer as base polymer.
(49) A PSA composition comprising carbon black particles and non-carbon black particles P_{HRI}, wherein
   the particles P_{HRI} consist of at least one species of particles selected among metal particles, metal compound particles, organic particles and organic/inorganic composite particles.
(50) The PSA sheet according to any of (11) to (48) above, used for fixing a component in a portable electronic device.
(51) The PSA sheet according to any of (11) to (48) above, that is placed on the backside of a screen in a portable electronic device.
(52) The PSA sheet according to any of (11) to (48) above, that is used in a portable electronic device comprising an optical sensor.
(53) The PSA sheet according to any of (11) to (48) and (50) to (52) above, that is applied to a material having a refractive index of 1.50 or higher.
(54) The PSA sheet according to (53) above, wherein the material has a total light transmittance of 80% or higher.
(55) A laminate having the PSA sheet according to any of (11) to (48) and (50) to (52) above, and a member to which the PSA sheet is adhered, wherein
   the member has a refractive index of 1.50 or higher.
(56) The laminate according to (55) above, wherein the member has a total light transmittance of 80% or higher.

### EXAMPLES

Several examples relating to the present invention will be described hereinbelow, but the present invention is not to be limited to these examples. In the description below, “parts” and “%” are by weight unless otherwise specified.

### Test Methods

### Total Light Transmittance

The total light transmittance (%) of the PSA sheet is the total light transmittance in the thickness direction of the PSA sheet peeled from the release liner and is determined based on JIS K 7136:2000, using a commercial transmissometer. As the transmissometer, product name HAZEMETER HM-150 available from Murakami Color Research Laboratory Co., Ltd. or a comparable product is used.

### Refractive Index

As for the refractive index of the PSA sheet, Condition (1) applies to the measurement when the total light transmittance of the PSA sheet is 50% or higher; Condition (2) applies to the measurement when the total light transmittance is below 50%.

### Condition (1)

Using a multi-wavelength Abbe refractometer, a measurement is taken at 589 nm wavelength at 23° C. As the multi-wavelength Abbe refractometer, model DR-M2 available from ATAGO Co., Ltd. or a comparable product is used.

### Condition (2)

Using a spectroscopic ellipsometer, at 23° C., the sodium D-line (589 nm) refractive index is determined In particular, the average surface refractive index of the PSA sheet surface (adhesive face) peeled from the release liner is determined. The measurement is carried out upon adhesion of a black sheet to the reverse side (unmeasured side) of the measurement side. As the spectroscopic ellipsometer, product name EC-400 available from J.A. Woollam Company or a comparable product is used.

### 180° Peel Strength (Adhesive Strength)

In a measurement environment at 23° C. and 50%RH, to one adhesive face of a double-faced PSA sheet, 50 µm thick PET film is applied for backing. The resultant is cut into a 10 mm wide and 100 mm long size to prepare a measurement sample. In an environment at 23° C. and 50%RH, the adhesive face of the measurement sample is press-bonded to the surface of a stainless steel plate (SUS 304BA plate) with a 2 kg roller moved back and forth once. The resultant is allowed to stand for 30 minutes in the same environment. Subsequently, based on JIS Z 0237:2000, using a universal tensile and compression tester, at a tensile speed of 300 mm/min at a peel angle of 180°, the peel strength (adhesive strength) (N/10 mm) is determined. As the universal tensile and compression tester, for instance, “tensile compression tester TG-1kN” by Minebea Co., Ltd., or an equivalent device is used. In case of a single-faced PSA sheet, the PET film backing is unnecessary.

### Breaking Strength

With respect to the breaking strength of the PSA sheet, Condition (1) applies to the measurement of a substrate-free PSA sheet not having a support substrate; Condition (2) applies to the measurement of a substrate-supported PSA sheet having a support substrate.

### Condition (1)

A release-film-lined PSA sheet is cut to a length of 150 mm and a width with a cross section area of 1 mm² to obtain a test piece. In an environment at 23° C. and 50%RH, upon removal of two release films, the PSA sheet (PSA layer) is cylindrically rolled. The resultant is used as a test piece. Using a tensile tester (universal tensile/compression testing machine, machine name “tensile and compression testing machine, TCM-1kNB” available from Minebea Co., Ltd.), at a chuck distance of 120 mm, at a tensile speed of 50 mm/min, a tensile test is performed on the test piece to obtain an S-S curve and determine the breaking strength (strength at break) (MPa) of the test piece.

### Condition (2)

A release-film-lined PSA sheet is cut to a width of 10 mm and a length of 150 mm to obtain a test piece. In an environment at 23° C. and 50%RH, two release films are removed to expose the PSA layer. Using a tensile tester (universal tensile/compression testing machine, machine name “tensile and compression testing machine, TCM-1kNB” available from Minebea Co., Ltd.), at a chuck distance of 120 mm, at a tensile speed of 50 mm/min, a tensile test is performed on the test piece to obtain an S-S curve and determine the breaking strength (strength at break) (MPa) of the test piece.

The thickness of the test piece used in the tensile test can be about the same as the thickness of the PSA sheet as described above, or can be different. For instance, when the PSA sheet has a relatively small thickness, for purposes such as operational facilitation, as the breaking strength of the PSA sheet, it is possible to use the result of the tensile test performed using a test piece prepared to a thickness of 5 µm or greater (e.g., about 5 µm to 200 µm). The thickness of the test piece can be adjusted, for instance, by suitably layering PSA sheets. Alternatively, using the same PSA composition as the one used in forming the PSA sheet being tested, a test piece having a thickness suited for tensile testing is prepared; and the result of the tensile test performed using this test piece can be used as the breaking strength of the PSA sheet. For instance, the tensile test can be carried out using an about 10 µm to 50 µm thick test piece. For testing, it is preferable to powder the area to be chucked in the adhesive face and eliminate the influence of stickiness of the PSA.

### Impact Resistance

Of a PSA sheet (double-faced PSA sheet) with adhesive faces protected with release liners, a square frame of 24.5 mm outer perimeter and 2 mm width is punched out to obtain a window-frame-shaped PSA sheet. Also obtained are a square stainless steel plate (2 mm thick, 50 mm by 50 mm square outer shape) with a central opening and a square PET plate (2 mm thick, 25 mm square outer shape); and between the two plates, the window-frame-shaped PSA sheet is placed upon removal of the release liners and press-bonded by evenly applying pressure at 62 N for 10 seconds to fix the stainless steel plate and PET plate with the window-frame-shaped PSA sheet. This is left standing in an environment at 50° C. for two hours, removed therefrom and allowed to cool back to 23° C. This is used as a test sample. On the table of a DuPont-type impact tester (available from Toyo Seiki Seisaku-sho, Ltd.), a cylindrical testing apparatus (50 mm long, 49 mm outer perimeter, 43 mm inner perimeter) is set up. On top of this, the test sample is loaded with the square PET plate down. The test sample is positioned so that the upper stainless steel plate is supported on the measurement base and the lower PET plate bonded to the stainless steel plate with the window-frame-shaped PSA sheet is placed in the middle open space of the testing apparatus. An impact head (punch) of 3.1 mm tip radius is placed on the PET plate which is on the lower side of the test sample. At 23° C. and 50%RH, a weight is dropped onto the impact head under the conditions (weight’s mass and drop height) shown below. The weight’s mass and drop height are initially set to have the lowest energy value and changed to increase the energy value. The weight’s drop height is increased incrementally by 50 mm. When changing the weight, testing is not conducted for the energy value (the energy value determined from the weight’s mass and drop height) at which testing has been already performed. Falling weight tests are carried out, setting the conditions (weight’s mass × weight’s drop height) not to duplicate energy values.

| | |
|---|---|
| (Weight’s mass) | (Weight’s drop height) |
| 100 g | 50 mm to 500 mm |
| 150 g | 350 mm to 500 mm |
| 200 g | 400 mm to 500 mm |
| 300 g | 350 mm to 500 mm |

The energy value (J) under a particular setting immediately before the setting at which peeling occurs between the stainless steel plate and PET plate is determined from the weight’s mass (load) and drop height and this is recorded as the measurement value of impact resistance. The impact resistance is graded as follows:

### Test Grades

Good: 0.15 J or greater
Poor: less than 0.15 J

### Determination of Particle Diameter of Particles P_{HRI} in PSA Layer

Under a liquid nitrogen atmosphere, a PSA sample is flash-frozen. In a freezing atmosphere at -30° C., using an ultramicrotome (model UC7 by Leica Microsystems GmbH), an approximately 100 nm thick slice is cut out of the sample to obtain an ultrathin section. Using a transmission electron microscope (TEM; by Hitachi High-Technologies Corporation; acceleration voltage 100 kV), the resulting ultrathin section is subj ected to TEM analysis. For one field of view (10 µm × 10 µm square) of a TEM image at about 40,000x magnification, image processing (binarization) is carried out to identify particles. With respect to all identified particles, the percent area coverage of each particle is determined. From the areas of individual particles, the circle equivalent (CE) diameters are determined. CE diameter is the diameter of a circle (true circle) having the same area as the area of the one particle being analyzed. This operation is carried out for four different fields of view in the TEM image (N = 4). The particles classified by CE diameter are plotted as a histogram in numbers to obtain a number-based particle size distribution. The number of particles on which the particle size distribution is based is obtained by counting the number of particles present in the one field of view. From the resulting particle size distribution, the mean particle diameter (nm) and the standard deviation (nm) are determined. For particle identification, analysis is carried out, excluding particles on edges of the image. For instance, imageJ can be used as the image analysis software.

### Example 1

### Preparation of Acrylic Polymer

Into a reaction vessel equipped with a stirrer, thermometer, nitrogen inlet, condenser and dropping funnel, were placed 95 parts of BA and 5 parts of AA as starting monomers and 233 parts of ethyl acetate as the polymerization solvent. The resulting mixture was allowed to stir under a nitrogen flow for two hours to eliminate oxygen from the polymerization system. Subsequently, was added 0.2 part of 2,2′-azobisisobutylonitrile as the polymerization initiator. The solution polymerization was carried out at 60° C. for eight hours to obtain a solution of acrylic polymer. The acrylic polymer had a Mw of about 70 × 10⁴.

### Preparation of PSA Composition

To the acrylic polymer solution, relative to 100 parts of acrylic polymer in the solution, were added 100 parts (by NV) of surface-treated zirconia particle dispersion A (ZrO₂-A) as particles P_{HRI}, 20 parts of terpene-phenol resin as a tackifier resin, 0.8 part of 1,2,3-benzotriazole (product name BT-120 available from Johoku Chemical Co., Ltd.) as a rust inhibitor, 3 parts of an isocyanate-based crosslinking agent and 0.01 part of an epoxy-based crosslinking agents as crosslinking agents. The resultant was stirred and mixed to prepare a PSA composition.

As the ZrO₂-A, was used a surface-treated zirconia particle dispersion obtained by dispersing surface-treated zirconia particles (mean particle diameter 40 nm; surface treatment: sulfonic acid-based hydrophobization; available from CIK NanoTek Corporation) in dimethylacetamide (DMA). As the terpene-phenol resin (tackifier resin), was used product name YS POLYSTAR T-115 (available from Yasuhara Chemical Co., Ltd.; softening point ~115° C., hydroxyl value 30-60 mgKOH/g). As the isocyanate-based crosslinking agent, was used product name CORONATE L (available from Tosoh Corporation; a 75% ethyl acetate solution of a trimethylolpropane/tolylene diisocyanate trimer adduct). As the epoxy-based crosslinking agent, was used product name TETRAD -C (available from Mitsubishi Gas Chemical Co., Inc.; 1,3-bis(N,N-diglycidylaminomethyl)cyclohexane).

### Preparation of PSA Sheet

To the release face of a 38 µm thick polyester release film (product name DIAFOIL MRF available from Mitsubishi Polyester Film Inc.), was applied the PSA composition and allowed to dry at 100° C. for two minutes to form a 20 µm thick PSA layer. To the PSA layer, was adhered the release face of a 25 µm thick polyester release liner (product name DIAFOIL MRF available from Mitsubishi Polyester Film Inc.). In this manner, was obtained a 20 µm thick substrate-free double-faced PSA sheet with both faces protected with the two polyester release liners.

### Examples 2 to 10

The PSA sheet thickness (PSA layer thickness), the species of particles P_{HRI} and amount thereof were set as shown in Table 1. Otherwise in the same manner as Example 1, a PSA composition was prepared according to each Example and the PSA composition was used to prepare a substrate-free double-faced PSA sheet. Particles P_{HRI} were not used in Example 10.

It is noted that the following abbreviations are used in Table 1:
ZrO₂-B: a surface-treated zirconia particle dispersion B obtained by dispersing surface-treated zirconia particles (mean particle diameter 20 nm; surface treatment: methacrylic functional group; available from CIK NanoTek Corporation) in methyl ethyl ketone (MEK)
TiO₂-A: a surface-treated titania particle dispersion A obtained by dispersing surface-treated titania particles (mean particle diameter 15 nm; surface treatment: methacrylic functional group; available from CIK NanoTek Corporation) in MEK
TiO₂-B: a surface-treated titania particle dispersion B obtained by dispersing surface-treated titania particles (mean particle diameter 15 nm; surface treatment: sulfonic acid-based hydrophobization; available from CIK NanoTek Corporation) in methyl propyl ketone (MPK)
TiO₂-C: a surface-treated titania particle dispersion C obtained by dispersing surface-treated titania particles (mean particle diameter 10 nm; surface treatment: methacrylic functional group; available from CIK NanoTek Corporation) in propylene glycol monomethyl ether (PGME)

### Example 11

In preparation of the PSA composition according to Example 1, was further added carbon black particles A (available from Dainichiseika Color & Chemicals Mfg. Co. Ltd.; product name ATDN101 Black; mean particle diameter 350 nm; “CB-A” in Tables) to 1.0% by weight in the PSA layer. Otherwise in the same manner as Example 1, was prepared a PSA composition according to this Example; and using the PSA composition, was prepared a 25 µm thick substrate-free double-faced PSA sheet.

### Examples 12 to 17

The PSA sheet thickness (PSA layer thickness), the species of carbon black particles and amount thereof were set as shown in Table 2. Otherwise in the same manner as Example 11, was prepared a PSA composition according to each Example; and using the PSA composition, was prepared a substrate-free double-faced PSA sheet.

It is noted that in Table 2, CB-B represents particulate carbon black B (mean particle diameter 90 nm; item No.3057 available from Mikuni Color Ltd.).

### Example 18

Were obtained 38 µm thick polyester release film (product name DIAFOIL MRF available from Mitsubishi Polyester Film Inc.) and 25 µm thick polyester release film (product name DIAFOIL MRF available from Mitsubishi Polyester Film Inc.). To the respective release faces of these release liners, was applied a PSA composition having the same composition as the one used in Example 12 to a dry thickness of 12.5 µm and allowed to dry at 100° C. for 2 min. PSA layers were thus formed on the release faces of the two release liners, respectively.

As the support substrate, was used 5 µm thick transparent PET film (product name LUMIRROR available from Toray Corporation). To the first and second faces of the support substrate, were adhered the PSA layers formed on the two release liners to prepare a substrate-supported double-faced PSA sheet (30 µm total thickness) according to this Example (transfer method). The release liners were left as they were on the PSA layers and used to protect the surfaces (adhesive faces) of the PSA layers.

### Example 19

Each PSA layer was formed 19 µm thick and the thickness of support substrate (PET film) was changed to 12 µm. Otherwise in the same manner as Example 18, was prepared a substrate-supported double-faced PSA sheet (50 µm in total thickness) according to this Example.

### Example 20

Particles P_{HRI} were not used and the PSA sheet thickness (PSA layer thickness) was changed to 35 µm. Otherwise in the same manner as Example 13, was prepared a substrate-free double-faced PSA sheet according to this Example.

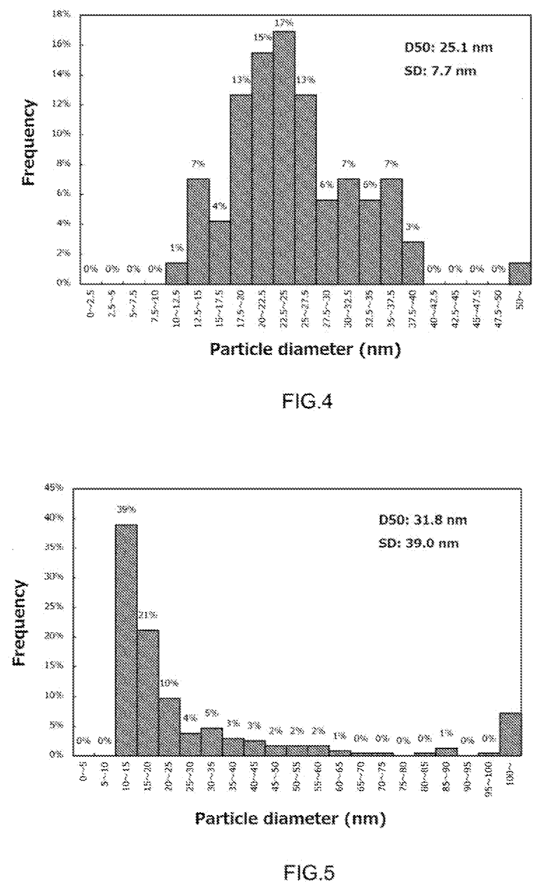

Tables 1 and 2 show features of the PSA sheet according to each Example and the results of testing for total light transmittance, refractive index, adhesive strength, breaking strength and impact resistance. With respect to the PSAs of Examples 1 and 7, number-based particle size distributions of particles P_{HRI} by TEM analysis were obtained to determine the mean particle diameter (nm) and standard deviation (nm) of particles P_{HRI}. FIGS. 4 and 5 show the particle size distributions with the mean particle diameters (nm) and standard deviations (nm). As for the particle diameter ranges in FIGS. 4 and 5 for instance, “10 nm to 15 nm” means 10 nm or greater and less than 15 nm. The same applies to other numerical particle diameter ranges in the drawings.

TABLE 1

| | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|
| Structure | No substrate | No substrate | No substrate | No substrate | No substrate | No substrate | No substrate | No substrate | No substrate | No substrate |
| [symbol] | ZrO₂-A | TiO₂-A | TiO₂-B | ZrO₂-B | ZrO₂-A | ZrO₂-A | TiO₂-C | TiO₂-A | ZrO₂-A | - |
| [symbol] | 40 100 | 15 50 | 15 100 | 20 50 | 40 70 | 40 100 | 10 100 | 15 50 | 40 100 | - 0 |
| [symbol] | 20 | 25 | 25 | 35 | 35 | 35 | 35 | 50 | 50 | 35 |
| [symbol] | 74 | 77 | 76 | 55 | 57 | 69 | 58 | 65 | 63 | 86 |
| [symbol] | 1.59 | 1.54 | 1.62 | 1.52 | 1.55 | 1.59 | 1.53 | 1.54 | 1.62 | 1.47 |
| [symbol] | 4.2 | 2.5 | 0.5 | 5.5 | 5.2 | 4.9 | 2.3 | 2.9 | 6.3 | 6.7 |
| [symbol] | 6.2 | 0.75 | 7.4 | 0.75 | 4.3 | 6.2 | 5.5 | 0.75 | 7.4 | 0.35 |
| [symbol] | Good | Good | Good | Good | Good | Good | Good | Good | Good | Good |

[symbol]

[symbol]

indicates text missing or illegible when filed

TABLE 2

| | | Ex. 11 | Ex. 12 | Ex. 13 | Ex. 14 | Ex. 15 | Ex. 16 | Ex. 17 | Ex. 18 | Ex. 19 | Ex. 20 |
|---|---|---|---|---|---|---|---|---|---|---|---|
| Structure | | No substrate | No substrate | No substrate | No substrate | No substrate | No substrate | No substrate | w/ substrate Double-faced | w/ substrate Double-faced | No substrate |
| Particles P_{HRI} | Species | ZrO₂-A | ZrO₂-A | ZrO₂-A | ZrO₂-A | ZrO₂-A | ZrO₂-A | ZrO₂-A | ZrO₂-A | ZrO₂-A | - |
| | D50 (nm) | 40 | 40 | 40 | 40 | 40 | 40 | 40 | 40 | 40 | - |
| | Amount (pts)^{∗}1 | 100 | 100 | 100 | 100 | 100 | 100 | 100 | 100 | 100 | 0 |
| Carbon black | Species | CB-A | CB-B | CB-A | CB-B | CB-B | CB-A | CB-B | CB-B | CB-B | CB-A |
| | D50 (nm) | 350 | 90 | 350 | 90 | 90 | 350 | 90 | 90 | 90 | 350 |
| | Amount (%)^{∗}2 | 1.0 | 3.0 | 2.0 | 2.0 | 3.0 | 4.0 | 4.0 | 3.0 | 3.0 | 2.0 |
| PSA sheet thickness (µm) | | 25 | 25 | 30 | 30 | 35 | 35 | 35 | 30 | 50 | 35 |
| Total light transmittance (%) | | 8.9 | 0.05 | 6.7 | 8.9 | 0.25 | 0.43 | 0.11 | 0.25 | 0.25 | 2 |
| Refractive index | | 1.57 | 1.58 | 1.57 | 1.58 | 1.58 | 1.57 | 1.58 | 1.59 | 1.59 | 1.47 |
| Adhesive strength (N/10mm) | | 3.4 | 3.3 | 3.8 | 3.7 | 4.5 | 4.5 | 4.3 | 3.5 | 3.9 | 6.6 |
| Breaking strength (Mpa) | | 4.8 | 4.6 | 4.5 | 4.1 | 3.8 | 3.5 | 3.6 | 3000 | 3000 | 0.24 |
| Impact resistance | | Good | Good | Good | Good | Good | Good | Good | Poor | Poor | Good |

^{∗}1. Parts to 100 parts of acrylic polymer ^{∗}2. Percentage in the PSA layer

As shown in Tables 1 and 2, the PSA sheets according to Examples 1 to 9 and 11 to 17 had breaking strength values of 10 MPa or less, passing the impact resistance test. In these Examples, the PSA sheets had refractive indices of 1.50 or higher. On the other hand, in Examples 18 and 19 where the PSA sheets had breaking strength values greater than 10 MPa, good impact resistance was not obtained. In Examples 10 and 20, the PSA sheets had refractive indices below 1.50.

Although specific embodiments of the present invention have been described in detail above, these are merely for illustrations and do not limit the scope of claims. The art according to the claims includes various modifications and changes made to the specific embodiments illustrated above.

### REFERENCE SIGNS LIST

1, 2 PSA sheets
21 PSA layer
21A, 21B adhesive faces
31, 32 release liners

1. An adhesively double-faced pressure-sensitive adhesive sheet consisting of a pressure-sensitive adhesive layer and being free of a substrate, wherein
the pressure-sensitive adhesive sheet has a refractive index of 1.50 or higher and a breaking strength of 10 MPa or less.

2. The pressure-sensitive adhesive sheet according to claim 1, comprising at least one species of particles P_{HRI} selected among metal particles, metal compound particles, organic particles and organic/inorganic composite particles.

3. The pressure-sensitive adhesive sheet according to claim 2, wherein the particle P_{HRI} content is 25% to 75% by weight.

4. The pressure-sensitive adhesive sheet according to claim 2, wherein the particles P_{HRI} have a mean particle diameter in the range between 1 nm and 100 nm.

5. The pressure-sensitive adhesive sheet according to claim 2, comprising carbon black particles in addition to the particles P_{HRI}.

6. The pressure-sensitive adhesive sheet according to claim 1, having a thickness of 20 µm or greater and 50 µm or less.

7. The pressure-sensitive adhesive sheet according to claim 1, comprising an acrylic polymer as base polymer.

8. The pressure-sensitive adhesive sheet according to claim 1, that is formed from a pressure-sensitive adhesive composition comprising an isocyanate-based crosslinking agent and/or an epoxy-based crosslinking agent.

9. The pressure-sensitive adhesive sheet according to claim 1, having a 180° peel strength of 2 N/10 mm or greater to a stainless steel plate.

10. The pressure-sensitive adhesive sheet according to claim 1, used for fixing a component in a portable electronic device.
